(19) United States
(12) Patent Application Publication
(10) Pub. No.: US 2026/0112511 A1
(43) Pub. Date: Apr. 23, 2026

(54) NUCLEAR REACTOR AND METHOD OF AUTONOMOUS CONTROL OF SUCH NUCLEAR REACTOR

(71) Applicant: Copenhagen Atomics A/S, Kastrup (DK)

(72) Inventor: Aslak STUBSGAARD, Copenhagen K (DK)

(73) Assignee: Copenhagen Atomics A/S, Kastrup (DK)

(21) Appl. No.: 19/121,043

(22) PCT Filed: Oct. 23, 2023
(86) PCT No.: PCT/DK2023/050251

§ 371 Date: Apr. 14, 2025

(30) Foreign Application Priority Data
Oct. 21, 2022 (DK) PA202270508

(51) Int. Cl. G21C 7/36; G21C 15/02; G21C 15/24; G21C 17/112; G21D 3/00

(52) U.S. Cl. CPC G21C 7/36; G21C 15/02; G21C 15/24; G21C 17/112; G21D 3/001

(57) ABSTRACT

A nuclear reactor for maintaining a sustained nuclear fission chain reaction, the nuclear reactor comprising a vessel (1) having an interior (30,35), the nuclear reactor further comprising in the interior of the vessel: a nuclear reactor core (2), a primary heat exchange loop (3), a conduit (23) for transporting an internal as well as external heat change medium, a heat exchanging arrangement for exchanging heat between the primary heat exchange medium and the internal as well as external heat exchange medium, and at least one controller (50) configured to autonomously control the operation of the nuclear reactor relying on data originating inside the vessel (1).

### TECHNICAL FIELD

The disclosure relates to nuclear reactors and methods of controlling such nuclear reactors, in particular to the construction and design of an autonomously controlled nuclear reactors and methods of autonomous control of such nuclear reactors.

### BACKGROUND

The most common nuclear reactors are large and complicated pressurized water reactors (PWR) or boiling water reactors (BWR). Both PWRs and BWRs use ordinary water as both coolant and moderator, and commonly rely on active systems, such as backup diesel generators for safety, i.e. these reactors are not inherently safe. These nuclear reactors are controlled by a team of human operators from a control room. The complexity of these nuclear reactors, the complexity of their control, and the involvement of the plurality of human operators in the control of the nuclear reactor causes these common nuclear reactors to be expensive to operate and also leaves room for improving safety and reliability.

Many advanced nuclear reactor types can be made passively safe so that their operation does not need active backup systems. Such reactors are generally considered safer than traditional reactor types, like PWRs and BWRs because they do not rely on human or machine intervention to shut the reactor down safely in case of an emergency. Passively safe reactor concepts have been proposed within different reactor categories, among them are molten salt reactors (MSR), High-temperature gas-cooled reactors, liquid metal cooled solid fuel reactors, and a few advanced water reactors.

The primary safety function of a nuclear reactor is to prevent the release of radionuclides, both during normal operation, shutdown, or accident conditions. It has often been in part the role of human nuclear operators to make sure a reactor is controlled to prevent the release of radionuclides. It is a desire to develop new reactor concepts that can achieve this function without the need for human intervention, instead relying on the inherent safety of the design.

A molten salt reactor (MSR) is a nuclear reactor where the nuclear reactor coolant and/or the nuclear fuel is a molten salt, typically a fluoride or chloride salt, with a melting point of around ˜500° C., an operating temperature of around ˜600 to 700° C., and a boiling point of ˜1000° C. above the melting point. One of the many advantages of this type of reactor is that molten salts can be used as the heat transfer media at very high temperatures while still operating at or close to atmospheric pressure. Heat is extracted from such reactors by pumping the molten salt in a loop or by natural convection between the nuclear reactor core and a heat exchanger with the reactor power being directly proportional to the temperature drop across the heat exchanger and the flow rate. Due to their large negative temperature and void coefficients, molten salt reactors can be designed and constructed to be inherently self-regulating and have passive decay heat removal and are thus referred to as inherently safe.

JP2016176821A discloses a nuclear reactor with a monitoring unit monitoring the operation of the nuclear reactor using thermoacoustic sensors in the nuclear reactor core.

WO2021141882 discloses a sensor assembly for determining an operating characteristic of a nuclear reactor. The sensor assembly includes a solid-state lasing media doped with a fissile species and disposable within a core of the nuclear reactor and an optical fiber operably coupled to the solid-state lasing media and configured to extend out of the core of the nuclear reactor and to control system of the nuclear reactor. The fissile species include one or more of uranium, plutonium, americium, or californium. A method of determining an operating characteristic of a nuclear reactor includes during operation of the nuclear reactor; receiving from the optical fiber a laser light, analyzing the laser light, and based on the analysis of the laser light, determining the operating characteristic of the nuclear reactor.

US2015/0036779 discloses a nuclear reactor according to the preamble of claim 1 and a method according to the preamble of claim 24.

In order to make nuclear reactors mass deployable, there is a desire to have their cost of deployment lowered and increase their safety and reliability.

### SUMMARY

It is an object to provide a nuclear reactor that overcomes or at least reduces one of the problems above.

The foregoing and other objects are achieved by the features of the independent claims. Further implementation forms are apparent from the dependent claims, the description, and the figures.

According to a first aspect, there is provided a nuclear reactor for maintaining a sustained nuclear fission chain reaction, the nuclear reactor comprising a closed and preferably leaktight vessel, the vessel having an interior, the interior of the vessel containing:
a nuclear reactor core having a power output during the sustained nuclear fission chain reaction,
at least a primary heat exchange loop comprising a primary heat exchange medium pump for circulating a primary heat exchange medium in the primary heat exchange loop,
a conduit for transporting an internal as well as external heat exchange medium, the conduit fluidically connecting an inlet with an outlet,
the inlet penetrates the exterior of the vessel, and the outlet penetrates the exterior of the vessel,
a heat exchanging arrangement for exchanging heat between the primary heat exchange medium and the internal as well as external heat exchange medium, and
at least one controller configured to autonomously control the operation of the nuclear reactor including the power output of the nuclear reactor core (2) by adjusting the sustained nuclear fission chain reaction, relying on data originating inside the vessel, wherein
at least some of the data originating inside the vessel originates from one or more sensors arranged inside the vessel, the data originating from within the vessel preferably comprising at least one thermodynamic condition of the primary heat exchange medium.

By providing a nuclear reactor with a controller that autonomously controls the operation of the nuclear reactor and preferably exclusively relies on data that originates inside the vessel, a nuclear reactor is provided for which no external or human operation is needed, which greatly reduces the operation costs and improves the safety of the nuclear reactor. The resulting nuclear reactor is very simple in nature and neither requires nor accepts data input from an external computer or sensors which would be vulnerable to manipulation by a malicious actor, thus significantly improving the safety and reliability of the operation of the reactor and decreasing the cost of operation. The inherent safety of the reactor means that the controller is non-safety-critical and its function is not critical to the operation of the reactor.

In a possible interpretation form of the first aspect, the closed and preferably leaktight vessel, contains all of the components of the reactor, with the only penetration of the vessel being inlet and outlet openings for the internal as well as external heat exchange medium and an electric power connection for providing electric power to the components in the closed vessel.

In a possible implementation form of the first aspect, the reactivity of the nuclear reactor is controlled with closed loop control with the sensed process variable being a thermodynamic condition of the primary heat exchange medium sensed by a sensor, e.g. a temperature sensor or a radiation sensor, inside the vessel and communicated to the at least one controller.

In a possible implementation form of the first aspect, the at least one controller is configured to maintain operating parameters of the nuclear reactor within a specified range or ranges, thereby allowing for the heat generated by the nuclear reactor core, at least during normal operation of the nuclear reactor, to be transferred by the internal as well as external heat exchange medium in the heat exchanging arrangement and/or allowing the nuclear fission chain reaction in the nuclear reactor to be regulated.

In a possible implementation form of the first aspect, the at least one controller is configured to autonomously control the operation of the nuclear reactor relying on exclusively data originating inside the vessel.

In a possible implementation form of the first aspect, the nuclear reactor operates according to an inherently safe process that directly provides a passive safety component during a specific failure condition in all operational modes.

In a possible implementation form of the first aspect, the nuclear reactor does not require any active intervention on the part of an operator or electrical/electronic feedback in order to bring the reactor to a safe shutdown state.

In a possible implementation form of the first aspect, the nuclear reactor is inherently safe, and preferably does not rely on active systems for ensuring reactor safety.

In a possible implementation form of the first aspect, the at least one controller is configured to control the power output of the nuclear reactor core by adjusting the sustained nuclear fission chain reaction, preferably by adjusting the level of a liquid neutron moderating medium in the reactor core.

In a possible implementation form of the first aspect, the at least one controller is configured to control the power output of the nuclear reactor core by adjusting the height or position of a control rod inside or adjacent to the reactor core.

In a possible implementation form of the first aspect, the at least one controller is configured to control the power output of the nuclear reactor core as a function of the power being absorbed by the internal as well as external heat exchange medium in the heat exchanging arrangement, the function preferably being a function that ensures that the power output of the nuclear reactor core is substantially equal to the power being absorbed by the internal as well as external heat exchange medium in the heat exchanging arrangement, preferably taking into account heat that is transferred away from the nuclear reactor core in other ways, such as heat lost during normal operation through a decay heat removal system and or heat lost to a liquid moderator or solid moderator coolant.

In a possible implementation form of the first aspect, the at least one controller is configured to adjust the flow rate of the primary coolant, e.g. by adjusting the speed of the primary pump through instructing the drive that controls the speed of the electric motor that drives the primary pump. In a molten salt reactor, adjusting the flow rate of the primary coolant indirectly influences the reactivity assuming that the coolant temperatures remain constant.

In a possible implementation from of the first aspect, one or more of the heat exchange media are driven by natural convection instead of being pumped and are left to operate passively or controlled through e.g. throttling by a valve.

In a possible implementation form of the first aspect, the at least one controller is configured to maintain the temperature(s) of the primary heat exchange medium at one or more given position(s) in the primary loop at a specified temperature or within a specified temperature range.

In a possible implementation form of the first aspect, the at least one controller is configured to adjust the speed of the primary pump, preferably as a function of the at least one thermodynamic condition of the primary heat exchange medium, the at least one thermodynamic condition preferably originating from one or more of the sensors arranged inside the vessel, the function preferably comprising one or more of a proportional component, an integral component, a differential component, and/or the at least one controller 50 comprising a Model Predictive Controller.

In a possible implementation form of the first aspect, the at least one thermodynamic condition of the primary heat exchange medium comprises a temperature or a derivative thereof of the primary heat exchange medium sensed by a temperature sensor 9,9′ that is arranged in the interior.

In a possible implementation form of the first aspect, the temperature sensor is arranged in a thermowell (thermocouple well) or mounted on the pipe surface.

In a possible implementation form of the first aspect, the at least one controller comprises one or more of analog electronics, digital electronics, software for processing electronics values, mechanical logic, hydraulic and/or fluidic logic, and wherein the at least one controller preferably does not comprise an electronic digital programmable computer and preferably using a redundant architecture, even more preferably using a dissimilar redundant architecture.

In a possible implementation form of the first aspect, the nuclear reactor comprises a breaker circuit arrangement and the breaker circuit arrangement being configured to connect and disconnect at least one of the electric and/or electronic components in the interior to and from a source of electric power inside the vessel, the breaker circuit arrangement preferably comprising a circuit breaker controlled by one of the at least one the controller, the nuclear reactor being preferably being configured to end the nuclear reaction and enter a safe state upon disconnecting the at least one of the electric and/or electronic components in the interior from the source of electric power.

Breaker circuits are relatively simple and very robust. By using a breaker circuit, a reliable and robust system is provided for shutting down the reactor when needed. The inherent safety of the reactor and shutdown of the reactor by the breaker circuit means that the controller is non-safety-critical and its function is not critical to the operation of the reactor.

In a possible implementation form of the first aspect, the at least one controller is configured to start operation of the nuclear reactor by connecting the electric and/or electronic components to the source of electric power by switching the breaker circuit arrangement from an open position to a closed position.

In a possible implementation form of the first aspect, the at least one controller is configured to end the operation of the nuclear reactor by connecting the electric and/or electronic components to the source of electric power by switching the breaker circuit arrangement from an open position to a closed position.

In a possible implementation form of the first aspect, the breaker circuit arrangement comprises a circuit breaker and one of the at least one controller, the one of the at least one controller preferably comprising analog electronics and/or digital electronics that are configured to operate of the circuit breaker as either open or closed, the one of the at least one controller preferably not comprising an electronic digital programmable computer.

In a possible implementation form of the first aspect, the nuclear reactor is a molten salt nuclear reactor, the primary heat exchange medium is a fuel salt comprising fissile material, the primary heat exchange medium loop is a fuel salt loop, the primary heat exchange medium pump is a fuel salt pump, the heat exchanging arrangement comprises a primary heat exchanger, the primary heat exchange loop passes through the primary heat exchanger, and the at least one thermodynamic condition preferably comprises one or more of:
fuel salt temperature or a derivative thereof at a position between an outlet of the primary heat exchanger and a fuel salt inlet of the nuclear reactor core,
fuel salt temperature or a derivative thereof at a position between a fuel salt outlet of the nuclear reactor core and an inlet of the primary heat exchanger,
fuel salt flow rate, the fuel salt flow rate preferably being derived from the rotation speed of the primary pump.

In a possible implementation form of the first aspect, the molten salt reactor is designed and constructed to be inherently self-regulating and have passive decay heat removal and is preferably inherently safe.

In a possible implementation form of the first aspect, the interior contains a primary cooling salt loop passing through the primary heat exchanger for exchanging heat with the fuel salt and through a secondary heat exchanger preferably for exchanging heat with the internal as well as external heat exchange medium, the primary cooling salt loop comprising a secondary pump for circulating the primary cooling salt in the primary cooling salt loop, and the at least one thermodynamic condition preferably comprises one or more of:
primary cooling salt temperature or a derivative thereof at a position between an outlet of the secondary heat exchanger and a primary cooling salt inlet of the primary heat exchanger,
primary cooling salt temperature or a derivative thereof at a position between a primary cooling salt outlet of the primary heat exchanger and an inlet of the secondary heat exchanger,
primary cooling salt flow rate, the primary cooling salt flow rate preferably being derived from the rotation speed of the secondary pump.

In a possible implementation form of the first aspect, the interior contains a moderator arrangement for adjusting the level of moderation in the nuclear reactor core, and the at least one controller is configured to control the level of moderation in the nuclear reactor core as a function of the data originating from within the vessel.

In a possible implementation form of the first aspect, the liquid moderator and neutron reflector is heavy water or a molten hydroxide, preferably molten enriched lithium 7 deuteroxide salt (7LiOD).

In a possible implementation form of the first aspect, the interior comprises a liquid moderator loop, the liquid moderator loop comprising a moderator pump for circulating a liquid moderator in the moderator loop, the liquid moderator loop passing through the nuclear reactor core, and preferably passing through a liquid moderator heat exchanger, wherein the at least one thermodynamic condition preferably comprises one or more of:
liquid moderator temperature at a position between a liquid moderator outlet of the liquid moderator heat exchanger and a liquid moderator inlet of the nuclear reactor core,
liquid moderator temperature at a position between a liquid moderator outlet of the nuclear reactor core 2, and a liquid moderator inlet of the liquid moderator heat exchanger,
liquid moderator flow rate, the liquid moderator flow rate preferably being derived from the rotation speed of the tertiary pump.

In a possible implementation form of the first aspect, the at least one controller is configured to provide an output value, the output value comprising one or more of:
speed of the primary pump,
speed of a secondary pump,
speed of a tertiary pump,
speed of a liquid moderator pump,
speed of a blanket salt pump,
ending operation of the primary pump,
ending operation of a secondary pump,
ending operation of a tertiary pump,
ending operation of a liquid moderator pump,
ending operation of a blanket salt pump,
starting operation of the primary pump,
starting operation of a secondary pump,
starting operation of a tertiary pump,
starting operation of a liquid moderator pump,
starting operation of a blanket salt pump.

In a possible implementation form of the first aspect, the at least one controller comprises one or more of analog electronics, digital electronics and software for processing electronics values, mechanical logic, hydraulic logic, and the at least one controller preferably does not comprise an electronic digital programmable computer.

In a possible implementation form of the first aspect, the nuclear reactor is a molten salt reactor and the at least one controller is configured to perform one or more of:
adjusting primary pump speed to keep the fuel salt temperature at the reactor core outlet to approximately 700° C., preferably comprising decreasing primary pump speed to increase the fuel salt temperature at the fuel salt outlet, and increasing primary pump speed to decrease the fuel salt temperature at the reactor core outlet,
adjusting a tertiary pump speed, which adjusts the liquid moderator level in the nuclear reactor core and thus the reactivity, to keep the average fuel salt temperature between the reactor core inlet and fuel salt at the reactor core outlet at 650° C., preferably comprising increasing moderator pump speed to increase reactivity and increase the average temperature in the reactor core and decreasing moderator pump speed to decrease reactivity and decrease the average fuel salt temperature in the reactor core,
adjusting secondary pump speed to keep the fuel salt temperature at the reactor core inlet to approximately 600° C., preferably comprising increasing the secondary pump speed to decrease the temperature of the fuel salt at the fuel salt inlet and decreasing secondary pump speed to increase the temperature of the fuel salt at the fuel salt inlet,
adjusting moderator coolant pump speed to keep the temperature of the liquid moderator at the liquid moderator outlet of the nuclear reactor core at approximately 20° C., preferably comprising increasing moderator coolant pump speed to decrease the temperature of the liquid moderator at the liquid moderator outlet of the nuclear reactor core, and decreasing moderator coolant pump speed to increase the temperature of the liquid moderator at the liquid moderator outlet of the nuclear reactor core.

In a possible implementation form of the first aspect, the at the at least one controller is a controller having Proportional, Integral and/or Derivative components (PID controller), and/or to operate as a Model Predictive Controller.

In a possible implementation form of the first aspect, the at each pump in the interior is provided with a driver that receives a pump rotational speed signal from the at least one controller, preferably each driver being powered with electrical power through the circuit breaker which shuts off the pumps when the circuit breaker is tripped (switched).

In a possible implementation form of the first aspect, the interior comprises an uplink transmitter configured to transmit data from the controller to an external recipient, and preferably configured to only allow for one way transmission, i.e. only allowing transmission from the transmitter a receiver outside of the vessel.

In a possible implementation form of the first aspect, the data originating from inside the vessel comprise one or more of
neutron radiation level in the interior of the vessel, preferably from a radiation sensor arranged in the interior,
seismic data from a seismic sensor arranged in the interior of the vessel,
blanket salt temperature at a blanket salt inlet of the nuclear reactor core, a blanket salt loop in the interior comprising a blanket salt pump for circulating blanket cooling salt in the blanket salt loop,
blanket salt temperature at a blanket salt outlet of the nuclear reactor core, a blanket salt loop in the interior comprising a blanket salt pump for circulating blanket cooling salt in the blanket salt loop,
temperature of a gas that fills space in the interior of the vessel, if the interior comprises a hot area and a cold area, the temperature of the gas that fills the space in the hot area,
the signal from a leak detector associated with one or more of:
   the primary heat exchange loop,
   the conduit,
   a secondary heat exchange loop,
   a tertiary heat exchange loop,
   a liquid moderator loop,
   a liquid moderator coolant loop,
   a blanket salt loop,
a signal from a sensor indicative of an open and/or closed position of a door in the vessel for giving access to the interior.

In a possible implementation form of the first aspect, the fuel salt is a fluoride salt with a melting point of approximately 550° C., the primary coolant salt is a fluoride or chloride salt with a melting point of approximately 450° C., the blanket salt is preferably a fluoride salt with a melting point of approximately 550° C., the scrubber salt is preferably a fluoride salt with a melting point of approximately 550° C., the second coolant is preferably a nitrate salt with a melting point of approximately 250° C. and a decomposition temperature of approximately 570° C.

In a possible implementation form of the first aspect, the data the one of the at least one controller is configured to open one or more circuit breakers when one or more of the following conditions are not fulfilled:
leak detection sensors showing no leaks,
a radiation level is below a radiation threshold,
a derivative of a radiation level is below a derivative radiation threshold,
a hot area of the interior is between approximately 580° C. and approximately 720° C.,
fuel salt inlet temperature is between approximately 580° C. and approximately 720° C.,
fuel salt outlet temperature is between approximately 580° C. and approximately 720° C.,
primary coolant salt inlet temperature is between approximately 480° C. and approximately 720° C.,
primary coolant salt outlet temperature is between approximately 480° C. and approximately 720° C.,
second coolant salt inlet temperature is between approximately 300° C. and approximately 570° C.,
second coolant salt outlet temperature is between approximately 300° C. and approximately 570° C.,
blanket salt inlet temperature is between approximately 580° C. and approximately 720° C.,
blanket salt outlet temperature is between approximately 580° C. and approximately 720° C.,
scrubber salt inlet temperature is between approximately 580° C. and approximately 720° C.,
scrubber salt outlet temperature is between approximately 580° C. and approximately 720° C.,
liquid moderator inlet temperature is between approximately 5° C. and approximately 90° C.,
liquid moderator outlet temperature is between approximately 5° C. and approximately 90° C.,
liquid moderator coolant inlet temperature is between approximately 5° C. and approximately 90° C.,
liquid moderator coolant outlet temperature is between approximately 5° C. and approximately 90° C.

In a possible implementation form of the first aspect, the one of the at least one controller is configured to close the circuit breaker when there is no condition requiring the circuit breaker to be open.

In a possible implementation form of the first aspect, the controller comprises a time delay for starting priming of the pumps after the circuit breaker is switched on such that all liquids are able to fully drain back before into the tanks before re-priming, in cases where the circuit breaker was triggered for a short period only, as could be the case in a transient scenario.

In a possible implementation form of the first aspect, the interior of the vessel comprises a hot area and a cold area, the hot area comprising the nuclear reactor core, the primary heat exchange loop comprising the primary pump, the internal as well as external heat exchange medium conduit connecting and the heat exchanging arrangement comprising at least the primary heat exchanger for exchanging heat between the primary exchange medium and the internal as well as external heat exchange medium, and preferably a primary heat exchange medium dump tank, and the cold region preferably housing electronics, breaker circuit, and other heat sensitive components, electronics, sensors.

In a possible implementation form of the first aspect, the interior of the vessel comprises a hot area and a cold area separated by thermal insulation and or radiation shielding material, to minimize the heat loss and cooling requirements on the cold area and or to minimize radiation exposure of the electronics, breaker circuit, and other radiation sensitive components, electronics, sensors.

In a possible implementation form of the first aspect, each heat exchange loop contained in the interior has associated therewith a dump tank and a pump, the pump being configured be open to liquid when stopped to allow the entire heat exchange medium in the respective heat exchange medium loop to be drained into the dump tank associated with the heat exchange loop concerned when the pump associated with the heat exchange loop concerned stops, the dump tanks preferably being configured to allow decay heat of radionuclides in the respective liquids to be transmitted passively through the reactor vessel when the respective heat exchange medium is contained in the respective dump tank.

In a possible implementation form of the first aspect, the interior comprises critical and non-critical sensors, each critical sensor having at least one operating threshold, the at least one controller being configured to open a circuit breaker associated with a critical sensor when an operating threshold associated with the critical sensor concerned is exceeded.

In a possible implementation form of the first aspect, the critical and noncritical sensors comprise one or more of: thermocouples, liquid leak detection sensors, radiation monitors, preferably, the critical and/or noncritical sensors are provided with redundancy by having multiples thereof and processing the output of these multiples and the consensus of the multiples is used, preferably by one or more of analog electronics, software processing electronics values, or mechanical logic, hydraulic and/or fluidic logic, preferably using Boolean algorithms to ensure that failure of one or more critical or noncritical sensors does not result in an erroneous value used by the at least one controller.

In a possible implementation form of the first aspect, wherein the salt temperature is sensed by a first temperature sensor, preferably a thermocouple, providing a signal to the controller 50 maintaining the temperatures, and wherein a second picture sensor is provided, preferably a thermocouple sending a signal to the breaker circuit.

In a possible implementation form of the first aspect, the liquid moderator is heavy water.

In a possible implementation form of the first aspect, the liquid moderator is heavy water with additions of hydroxide or deutoxide, preferably enriched lithium 7 deutoxide (7LiOD) and preferably as an eutectic mixture, in order to lower the melting point of the heavy water and be able to operate the liquid moderator below 0° C. and, shifting the thermal neutron spectrum colder.

In a possible implementation form of the first aspect, the fuel salt comprises fissile components, preferably comprising enriched lithium 7 fluoride, thorium tetrafluoride, uranium tetrafluoride, uranium trifluoride and/or plutonium trifluoride (7LiF)-(ThF4)-(UF4)-(UF3)-(PuF3) salt.

In a possible implementation form of the first aspect, the fuel salt comprises fissile components, preferably comprising enriched lithium 7 fluoride, uranium tetrafluoride, low enriched uranium trifluoride (7LiF)-(UF4)-(UF3) salt.

In a possible implementation form of the first aspect, the blanket salt is a molten salt comprising fertile components, preferably comprising enriched lithium 7 fluoride and/or thorium tetrafluoride (7LiF)-(ThF4) salt.

According to a second aspect, there is provided a method of operating the nuclear reactor according to any one of the preceding claims, comprising determining the power output of the molten salt nuclear reactor by controlling the amount of power absorbed by the internal as well as external heat exchange medium flowing through the heat exchange medium conduit, preferably by controlling the flow rate of the internal as well as external heat exchange medium through the conduit.

By providing a method in which the power output of the nuclear reactor is automatically adapted to the amount of power that is absorbed by the internal as well as external heat exchange medium, the power output of the nuclear reactor can be controlled by controlling the power that is removed from the nuclear reactor by the consumer of heat. Thus, there is neither need for an external controller to send a power setting signal to the nuclear reactor, nor for any other external signal to be sent to the nuclear reactor or human operators of the reactor.

By providing a method of controlling a nuclear reactor which is inherently safe, and by the nuclear reactor comprising a breaker circuit relying preferably exclusively on data originating from within the vessel and the breaker circuit controller have specified limits, such as thermodynamic conditions or states, for which the reactor is deemed safe to operate, the reactor can be operated by a non-safety critical controller without the risk of radionuclide release, since any limit exceeded would lead to the breaker circuit(s) switching thereby shutting down of the reactor. Thus, there is neither need for an external controller to send a shutdown or startup signal to the nuclear reactor, nor for any other external signal to be sent to the nuclear reactor or human operators of the reactor. Moreover, it is a safety benefit that no humans are involved, thereby removing the risk of human error and it is a safety benefit that this method of controlling the nuclear reactor reduces possible attack vectors.

According to the third aspect, there is provided a method of operating a nuclear reactor that maintains a sustained nuclear fission chain reaction, the nuclear reactor comprising a closed and preferably leaktight vessel, the vessel having an interior the interior of the vessel containing:
a nuclear reactor core having a power output during the sustained nuclear fission chain reaction,
at least a primary heat exchange loop comprising a primary heat exchange medium pump for circulating a primary heat exchange medium in the primary heat exchange loop, and
a conduit for transporting an internal as well as external heat exchange medium, the conduit fluidically connecting an inlet with an outlet,
the inlet penetrates the exterior of the vessel, and the outlet penetrates the exterior of the vessel,
a heat exchanging arrangement for exchanging heat between the primary heat exchange medium and the internal as well as external heat exchange medium,
the method comprising autonomously control the operation of the nuclear reactor, including the power output of the nuclear reactor core (2) by adjusting the sustained nuclear fission chain reaction, relying preferably exclusively on data originating inside the vessel, at least some of the data originating inside the vessel originating from one or more sensors arranged inside the vessel, the data originating from within the vessel preferably comprising at least one thermodynamic condition of the primary heat exchange medium.

According to a fourth aspect, there is provided a nuclear reactor for maintaining a sustained nuclear fission chain reaction, comprising a vessel having a leaktight interior, the interior containing: a nuclear reactor core, a primary heat exchange loop, a conduit for transporting an internal as well as external heat exchange medium, a heat exchanging arrangement for exchanging heat between the primary heat exchange medium and the internal as well as external heat exchange medium, and at least one controller configured to autonomously control the operation of the nuclear reactor relying preferably exclusively on data originating inside the vessel.

According to a fifth aspect, there is provided nuclear reactor for maintaining a sustained nuclear fission chain reaction, the nuclear reactor comprising a closed and preferably leaktight vessel, the vessel having an interior, the interior of the vessel containing:
a nuclear reactor core,
at least a primary heat exchange loop comprising a primary heat exchange medium pump for circulating a primary heat exchange medium in the primary heat exchange loop,
at least one sensor configured to provide a signal representative of an operation state of the nuclear reactor,
a breaker circuit arrangement comprising a circuit breaker, the breaker circuit arrangement being configured to connect and disconnect at least one of the electric and/or electronic components in the interior to and from a source of electric power inside the vessel, the breaker circuit arrangement, comprising a circuit breaker having an open and a closed state, the breaker circuit arrangement being connected to the at least one sensor, and the breaker circuit being configured to open a circuit breaker when the signal from the at least one sensor exceeds a safety threshold, preferably a safety threshold that indicates that the nuclear reactor is operated in an undo manner, a failure of a critical component has occurred, or another safety critical threshold has been exceeded.

By providing a breaker circuit arrangement that is triggered by a signal sensor configured to provide a signal representative of an operation state of the nuclear reactor it is possible to create a nuclear reactor that automatically shuts down in a safe manner when the reactor approaches or reaches an unsafe state without needing human intervention, thereby significantly reducing risk of human error.

In a possible implementation form of the fifth aspect, electric and/or electronic components comprise an electric motor driving the primary exchange pump.

In a possible implementation form of the fifth aspect, at least one sensor comprises a sensor configured to sense a temperature of the primary heat exchange medium.

In a possible implementation form of the fifth aspect, the nuclear reactor is configured to end the nuclear reaction and enter a safe state upon disconnecting the at least one of the electric and/or electronic components in the interior from the source of electric power.

In a possible implementation form of the fifth aspect, the nuclear reactor is configured to start operation when the electric and/or electronic components are connected to the source of electric power, preferably by switching the breaker circuit arrangement from an open position to a closed position.

In a possible implementation form of the fifth aspect, the nuclear reactor is configured to end operation by disconnecting the electric and/or electronic components to the source of electric power, preferably by switching the breaker circuit arrangement from an open position to a closed position.

In a possible implementation form of the fifth aspect, the breaker circuit arrangement comprises a circuit breaker and a controller, the controller preferably comprising analog electronics and/or digital electronics that are configured to operate of the circuit breaker as either open or closed, the one of the at least one controller preferably not comprising an electronic digital programmable computer.

In a possible implementation form of the fifth aspect, the nuclear reactor is a molten salt nuclear reactor, the primary heat exchange medium is a fuel salt comprising fissile material, the primary heat exchange medium loop is a fuel salt loop, the primary heat exchange medium pump is a fuel salt pump, the heat exchanging arrangement comprises a primary heat exchanger, the primary heat exchange loop passes through the primary heat exchanger, and wherein the at least one sensor comprises one or more of:
a fuel salt temperature sensor at a position between an outlet of the primary heat exchanger and a fuel salt inlet of the nuclear reactor core,
a fuel salt temperature at a position between a fuel salt outlet of the nuclear reactor core and an inlet of the primary heat exchanger,
a fuel salt flow rate sensor, the fuel salt flow rate preferably being derived from the rotation speed of the primary pump.

In a possible implementation form of the fifth aspect, the breaker circuit arrangement is configured to require the safety threshold to be exceeded for a predetermined amount of time before switching a circuit breaker to the open position.

In a possible implementation form of the fifth aspect, the breaker circuit arrangement is configured use the first or second derivative of a signal from the at least one sensor, in addition or instead of the value of the signal itself, for determining if a safety threshold has been exceeded.

In a possible implementation form of the fifth aspect, the sensor is arranged inside the interior.

According to a sixth aspect there is provided a method of operating a nuclear reactor that maintains a sustained nuclear fission chain reaction, the nuclear reactor comprising a closed and preferably leaktight vessel, the vessel having an interior, the interior of the vessel containing:
a nuclear reactor core,
at least a primary heat exchange loop comprising a primary heat exchange medium pump for circulating a primary heat exchange medium in the primary heat exchange loop,
at least one sensor configured to provide a signal representative of an operation state of the nuclear reactor,
a breaker circuit arrangement comprising a circuit breaker, the breaker circuit arrangement being configured to connect and disconnect at least one of the electric and/or electronic components in the interior to and from a source of electric power inside the vessel, the breaker circuit arrangement, comprising a circuit breaker having an open and a closed state, the breaker circuit arrangement being connected to the at least one sensor,
the method comprising the breaker circuit arrangement determining that the signal from the at least one sensor exceeds a safety threshold, preferably a safety threshold that indicates that the nuclear reactor is operated in an undo manner, a failure of a critical component has occurred, or another safety critical threshold has been exceeded, and
opening a circuit breaker when it has been determined that the signal from the at least one sensor exceeds a safety threshold.

According to a seventh aspect there is provided a nuclear reactor for maintaining a sustained nuclear fission chain reaction, the nuclear reactor comprising a closed and preferably leaktight vessel, the vessel having an interior, the interior of the vessel containing:
a nuclear reactor core,
at least a primary heat exchange loop comprising a primary heat exchange medium pump for circulating a primary heat exchange medium in the primary heat exchange loop,
a conduit for transporting an internal as well as external heat exchange medium, the conduit fluidically connecting an inlet with an outlet,
the inlet penetrates the exterior of the vessel, and the outlet penetrates the exterior of the vessel,
a heat exchanging arrangement for exchanging heat between the primary heat exchange medium and the internal as well as external heat exchange medium,
at least one sensor configured to provide a signal representative of an operation state of the nuclear reactor, and
a breaker circuit arrangement comprising a circuit breaker, the breaker circuit arrangement being configured to connect and disconnect at least one of electric and/or electronic components in the interior to and from a source of electric power inside the vessel, the breaker circuit arrangement, comprising a circuit breaker having and open and a closed state, the breaker circuit arrangement being connected to the at least one sensor,
and the breaker circuit arrangement being configured to open a circuit breaker when the signal from the at least one sensor exceeds a safety threshold, preferably a safety threshold that indicates that the molten salt nuclear reactor is operated in an undo manner, a failure of a critical component has occurred, or another safety critical threshold has been exceeded.

In a possible implementation form of the seventh aspect, the electric and/or electronic components comprise one or more of:
an electric motor driving the primary heat exchange medium pump,
an actuator of a normally closed valve in a fluid supply conduit of a turbine or a fluid driven engine driving the primary heat exchange medium pump,
be an actuator of a normally open salt valve that allows the molten salt primary heat exchange medium to drain from the molten salt primary heat exchange loop when the normally open salt valve is open.

In a possible implementation form of the seventh aspect, the at least one sensor comprises a sensor configured to sense a temperature of the primary heat exchange medium.

In a possible implementation form of the seventh aspect, the nuclear reactor is configured to end the nuclear reaction and enter a safe state upon disconnecting the at least one of electric and/or electronic components in the interior from the source of electric power.

In a possible implementation form of the seventh aspect, the nuclear reactor is configured to start operation when the electric and/or electronic components are connected to the source of electric power, preferably by switching the breaker circuit arrangement from an open position to a closed position.

In a possible implementation form of the seventh aspect, the nuclear reactor is configured to end operation by disconnecting the electric and/or electronic components to the source of electric power, preferably by switching the breaker circuit arrangement from an open position to a closed position.

In a possible implementation form of the seventh aspect, the breaker circuit arrangement comprises a circuit breaker and a controller, the controller comprising analog electronics and/or digital electronics that are configured to operate of the circuit breaker as either open or closed.

In a possible implementation form of the seventh aspect, the at least one sensor comprises one or more of:
a fuel salt temperature sensor at a position between an outlet of the primary heat exchanger and a fuel salt inlet of the nuclear reactor core, a fuel salt temperature at a position between a fuel salt outlet of the nuclear reactor core and an inlet of the primary heat exchanger, a fuel salt flow rate sensor, the fuel salt flow rate preferably being derived from the rotation speed of the primary pump.

In a possible implementation form of the seventh aspect, the breaker circuit arrangement is configured to require the safety threshold to be exceeded for a predetermined amount of time before switching a circuit breaker to the open position.

In a possible implementation form of the seventh aspect, the breaker circuit arrangement is configured to use the first or second derivative of a signal from the at least one sensor, in addition or instead of the value of the signal itself, for determining if a safety threshold has been exceeded.

In a possible implementation form of the seventh aspect, the at least one sensor is arranged inside the interior.

In a possible implementation form of the seventh aspect, the primary heat exchange medium pump is of an open type that is open for passage of the primary heat exchange medium when the primary pump is not operating, wherein the primary heat exchange loop is fluidically connected to a primary exchange medium drain tank and wherein the nuclear reactor is configured to allow the primary heat exchange medium to drain by the effect of gravity into the primary exchange medium drain tank when the primary pump is stopped, regardless of the cause of the primary pump being stopped, preferably without the need of any flow control elements, such as valves.

In a possible implementation form of the seventh aspect, the primary heat exchange medium pump is a centrifugal type pump.

In a possible implementation form of the seventh aspect, the primary heat exchange medium contains fissile material and the primary heat exchange medium drain tank is configured for passive decay heat removal.

According to an eighth aspect, there is provided a method of operating a nuclear reactor that maintains a sustained nuclear fission chain reaction, the nuclear reactor comprising a closed and preferably leaktight vessel, the vessel having an interior, the interior of the vessel containing:
a nuclear reactor core,
at least a primary heat exchange loop comprising a primary heat exchange medium pump for circulating a primary heat exchange medium in the primary heat exchange loop, and
a conduit for transporting an internal as well as external heat exchange medium, the conduit fluidically connecting an inlet with an outlet,
the inlet penetrates the exterior of the vessel, and the outlet penetrates the exterior of the vessel,
a heat exchanging arrangement for exchanging heat between the primary heat exchange medium and the internal as well as external heat exchange medium,
at least one sensor configured to provide a signal representative of an operation state of the nuclear reactor, and
a breaker circuit arrangement comprising a circuit breaker, the breaker circuit arrangement being configured to connect and disconnect at least one of electric and/or electronic components in the interior to and from a source of electric power inside the vessel, the breaker circuit arrangement, comprising a circuit breaker having and open and a closed state, the breaker circuit arrangement being connected to the at least one sensor, the method comprising determining that the signal from the at least one sensor exceeds a safety threshold, preferably a safety threshold that indicates that the nuclear reactor is operated in an undo manner, a failure of a critical component has occurred, or another safety critical threshold has been exceeded, and
opening a circuit breaker when it has been determined that the signal from the at least one sensor exceeds a safety threshold.

In a possible implementation form of the eighth aspect, the primary heat exchange medium to drain from the primary heat exchange loop at under the influence of gravity to a primary heat exchange medium drain tank arranged below the primary exchange loop when the circuit breaker is opened.

In a possible implementation form of the eighth aspect, the primary heat exchange pump is stopped when the circuit breaker is opened and wherein the primary heat exchange medium is allowed to drain from the primary heat exchange loop under the influence of gravity, at least partially through the primary heat exchange pump.

In a possible implementation form of the eighth aspect, the at least one of electric and/or electronic components in the interior comprise:
an electric motor driving the primary heat exchange medium pump,
an actuator of a normally closed valve in a fluid supply conduit of a turbine or a fluid driven engine driving the primary heat exchange medium pump,
an actuator of a normally open salt valve that allows the molten salt primary heat exchange medium to drain from the molten salt primary heat exchange loop when the normally open salt valve is open.

These and other aspects will be apparent from the embodiments described below.

### BRIEF DESCRIPTION OF THE DRAWINGS

In the following detailed portion of the present disclosure, the aspects, embodiments, and implementations will be explained in more detail with reference to the example embodiments shown in the drawings, in which:

FIG. 1 is a diagrammatic representation of a first embodiment of a nuclear reactor connected to a consumer of heat,

FIG. 2 is a diagrammatic representation of a second embodiment of a nuclear reactor connected to the consumer of heat,

FIG. 3 is a diagrammatic representation of a third embodiment of a nuclear reactor connected to the consumer of heat,

FIG. 4 is a diagrammatic representation of a fourth embodiment of a nuclear reactor of a molten salt type,

FIG. 5 is a diagrammatic representation of a fifth embodiment of a nuclear reactor of a molten salt type,

FIG. 6 is a diagrammatic representation of a sixth embodiment of a nuclear reactor of a molten salt type, and

FIG. 7 is a diagrammatic representation of a seventh embodiment of a nuclear reactor of a molten salt type.

### DETAILED DESCRIPTION

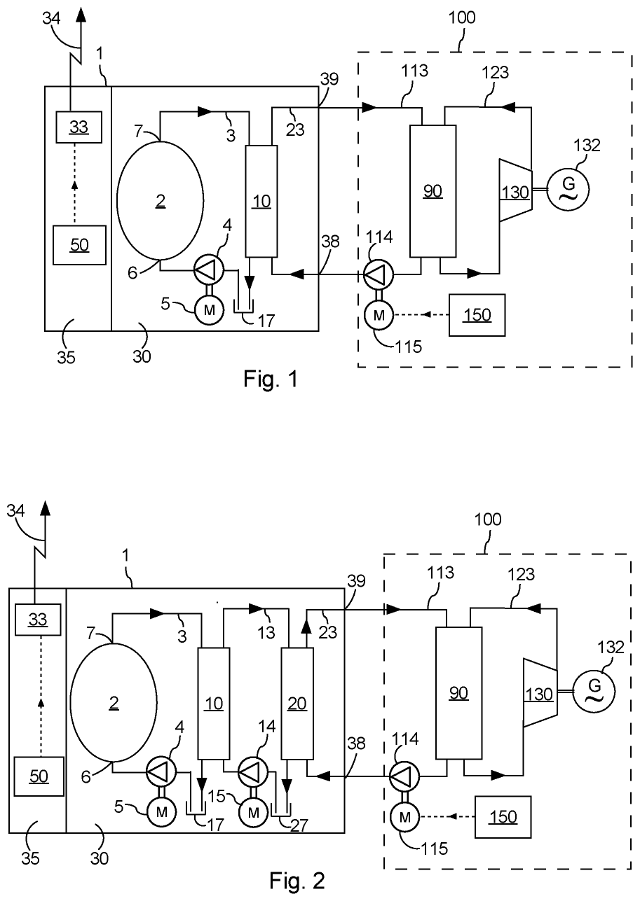

FIG. 1 illustrates a first embodiment of a nuclear reactor 1. The nuclear reactor is arranged in the interior of a hermetically sealed vessel 1, also referred to as “reactor vessel”. The hermetically sealed vessel 1 forms an airtight housing in which the components of the nuclear reactor are located. In an embodiment, the reactor vessel 1 is a metal, preferably steel, casing, e.g. a casing with metal or steel walls. In an embodiment, the reactor vessel 1 is provided with two or more layers of airtightness, i.e. double, triple, etc. walled vessel, the third barrier e.g. serving in particular radiation protection (not illustrated in FIG. 1).

The interior of the reactor vessel 1 is optionally divided into a hot area 30, sometimes referred to as “furnace”, and a cool area 35. The interior of the vessel 1 contains a nuclear reactor core 2, preferably in the hot area 30, and a primary heat exchange loop 3, for transporting heat away from the nuclear reactor core 2, preferably also in the hot area 30 by circulating a primary heat exchange medium. Temperature-sensitive equipment, such as electrical power supply systems and electronics, e.g. controller 50, uplink transmitter 33 are as far as possible arranged in the cool area 35.

The nuclear reactor is one or more of the following types of reactors (nonexhaustive list), pressurized water reactor, boiling water reactor, pressurized heavy water reactor, gas-cooled reactor, molten salt reactor, fast neutron reactor. The primary heat exchange medium is determined by the reactor type and can be one or more of the following (nonexhaustive list), water, heavy water, helium, carbon dioxide, sodium, molten salt (fluoride or chloride salt), lead or lead-bismuth eutectic. depending on the type of reactor, the primary heat exchange medium not only serves to remove heat from the reactor but has additional functions, e.g. acting as moderator or containing the nuclear fuel.

During the operation of the nuclear reactor, a sustained nuclear-controlled chain reaction takes place in the nuclear reactor core 2. Active and passive control of the sustained chain reaction involves adjusting the level of fission-inducing neutrons in the reactor core 2, and the way in which this is achieved may depend on the reactor type. In some types of reactors adjusting the level of fission-inducing neutrons in the reactor core 2 involves movement of control rods made of highly neutron absorbing material and therefore absorb neutrons. One or more control rods (not shown) are inserted deeper into the nuclear reactor core 2, to absorb more neutrons than the material or medium it displaces. This action results in fewer neutrons available to cause fission and reduces the power output of the nuclear reactor. Conversely, extracting one or more control rods will result in an increase in the rate of fission events and an increase in power output of the nuclear reactor. In other types of nuclear reactors, adjusting the level of fission-inducing neutrons in the nuclear reactor core 2 involves adjusting the temperature or the amount of moderator present in the nuclear reactor core 2. In case of a liquid moderator, the temperature of the liquid moderator is decreased resulting in a higher density of the liquid moderator or the level or amount of liquid moderator in the nuclear reactor core 2 is increased to increase the level of fission-inducing neutrons in the reactor core 2 by causing a larger proportion of fast neutrons that are released from fission to lose energy and become thermal neutrons that are more likely than fast neutrons to cause fission or less likely to leak out of the reactor core 2, and vice versa.

In the embodiment of FIG. 1 the nuclear reactor is a molten salt reactor, by way of example. In this embodiment, the primary heat exchange loop 3 comprises a primary pump 4 for circulating the primary heat exchange medium in the primary heat exchange loop 3. The primary pump 4 is a circulation pump that is driven by a primary motor 5, which is preferably an electric drive motor provided with a motor drive for adjusting the speed of the electric motor 5. Heaters (not shown), e.g. electric heaters are provided for each heat exchange loop that contains a heat exchange medium that is solid at normal room or environment temperatures, to allow the medium to warm up to the liquid phase so that the heating medium can be pumped.

The primary heat exchange loop 3 extends through the nuclear reactor core 2, and accordingly, the nuclear reactor core 2 is provided with a primary heat exchange medium inlet 6 and a primary heat exchange medium outlet 7 that connect the portion of the primary heat exchange loop 3 that extends through the nuclear reactor core 2. The primary heat exchange loop 3 passes through a primary heat exchanger 10 for exchanging heat with an internal as well as external heat exchange medium and through the primary heat exchange medium tank 17 which forms the lowest part of the primary heat exchange loop 3. The primary pump 4 pumps the primary heat exchange medium up from the primary exchange medium drain tank 17. The primary pump 4 is driven by a primary electric motor 5 and the primary pump 4 is of an open type, e.g. a centrifugal type pump that is open for passage of primary heat exchange medium when the primary pump 4 is not operating (stopped). Thus, the primary heat exchange medium will drain by the effect of gravity into the primary exchange medium drain tank 17 when the primary pump 4 is stopped, regardless of the cause of the primary pump 4 being stopped, without the need for any flow control elements, such as valves or pumps to ensure passive safety. The primary heat exchange medium drain tank 17 is configured for passive decay heat removal, the drain tank preferably comprises passive cooling means for removing heat from the drain tank 17, e.g. conductive heat transfer through the bottom of the tank or from a cooling medium passing though the tanks and driven by buoyancy to achieve passive convective cooling.

A conduit 23 for removing heat from the interior of the reactor vessel 1 is arranged in the interior of the reactor vessel 1. An internal as well as external heat exchange medium flows through the conduit 23. In an embodiment, the internal as well as external heat exchange medium is a molten nitrate salt, but it could also be another type of salt, or another type of suitable liquid, gas, or vapor. The internal as well as external heat exchange medium is pumped through the internal as well as external heat exchange medium conduit 23, which passes through the first heat exchanger 10 to remove heat produced from the primary heat exchange medium and convey this heat to a consumer of heat 100. The conduit 23 fluidically connects an inlet 38 with an outlet 39. Both the inlet 38 and the outlet 39 penetrate the walls of the vessel 1 for connecting to an exterior consumer of heat 100.

The consumer of heat 100 is arranged exterior to reactor vessel 1 and fluidically connected to the reactor vessel 1 at the heat exchange medium inlet port 38 and at the heat exchange outlet port 39, and the consumer of heat does not form part of the nuclear reactor. In this example, the consumer of heat 100 comprises an external conduit 113, which together with the heat exchange conduit 23 forms an internal as well as external heat exchange liquid loop that passes through an external heat exchanger 90. The external conduit 113 is fluidically connected to both the inlet port 38 and at the outlet port 39. An external pump 114 driven by an external electric motor 115 forces a circulating flow of internal as well as external heat exchange medium through the internal as well as external heat exchange loop. An external controller 150 adjusts the speed of the external pump 114 to control the amount of heat that is absorbed by the internal as well as external heat exchange medium, and thus, to control the amount of heat that is transported out of the nuclear reactor. The external heat exchanger 90 is in this example a boiler configured to exchange heat with a steam loop 123 that in turn is connected to a steam turbine 130 driving an alternator 132 to generate electric power. However, it is understood that the heat that is received by the customer of heat 100 could be used for any other purpose, i.e. any process that requires heat, e.g. industrial processes, district heating, or desalination, and that the electricity, besides being supplied to an electric grid, can be used for industrial purposes such as hydrogen production, hydrogen production for ammonia production, and metal refinement and/or recycling.

A number of sensors are provided in the interior of the vessel 1 to provide data originating inside the vessel data relating to the operation of the nuclear reactor.

At least the primary exchange loop 3 is provided with temperature sensors, for example in the form of thermocouples (not shown in FIG. 1), for sensing the temperature of the primary exchange medium. The temperature sensors generate a signal representative of the temperature that is sensed. For temperatures that are critical information, there will be two or more sensors for providing redundancy. In an embodiment, the temperature sensors are arranged in a thermowell (thermocouple well) or mounted on the pipe surface (of the pipe transporting/containing medium for which the temperature is to be sensed).

In an embodiment, a first and second temperature sensor (not shown), two sensors for redundancy reasons, are arranged at primary exchange loop 3 (between the primary heat exchange medium outlet 7, and the primary exchange medium inlet of the secondary heat exchanger 20) for sensing the temperature of the primary exchange medium leaving the reactor core 2. A second temperature sensor is arranged at the primary exchange loop 3 between the primary heat exchange medium outlet of the secondary heat exchanger 20 and the primary heat exchange medium inlet 6 for sensing the temperature of the primary exchange medium that is supplied to the reactor core 2.

Additional sensors that are arranged in the interior of the vessel 1 can be one or more of, radiation sensor, pressure sensor, vibration sensor, sound sensor, light sensor, camera sensor, flow rate sensor for sensing the flow rate of the liquid in any of the heat exchange loops or in a moderator loop (flow meter (e.g. turbine flow meter, venturi flow meter, elbow flow meter, ultrasonic flow meter) or pump speed sensor), pressure sensor for sensing pressure in any of the heat exchange loops or in a moderator loop, liquid composition sensor (e.g. electrochemical sensor, laser induced breakdown spectrometry sensor, Rayman spectrometry sensor) for sensing the composition of the liquid in any of the heat exchange loops or moderator loop, gas composition sensor, gas leak detection sensor, liquid leak detection sensor, seismic sensor, tilt sensor, door switch sensor, electromagnetic pulse sensor, and geolocation sensor, A controller 50 is arranged in the interior of the reactor vessel 1 preferably as far as possible in the cool area 35. The controller 50 is in an embodiment a distributed controller. The controller 50 does not receive any signals from the exterior of the reactor vessel 1, and operates/relies on the basis of data that is generated inside the reactor vessel 1, preferably exclusively on the basis of data that is generated inside the reactor vessel 1. The data that is generated inside the reactor vessel 1 originates, at least in part, from sensors that are arranged inside the reactor vessel 1. The controller 50 is in receipt of a signal of one or more sensors that are arranged inside the reactor vessel 1.

The controller 50 is configured to autonomously and without human intervention control the operation of the nuclear reactor, relying preferably exclusively on data that has originated from within the reactor vessel 1. The data originating from within the vessel 1 preferably comprises at least one thermodynamic condition of the primary heat exchange medium.

The controller 50 is configured to control power output of the nuclear reactor core 2 by adjusting the sustained nuclear fission chain reaction, by adjusting the level of fission-inducing neutrons in the reactor core 2. The controller 50 is configured to control the power output of the nuclear reactor by adjusting the amount of heat produced by the nuclear reactor to the amount of heat removed from the nuclear reactor by the internal as well as external heat exchange medium by controlling the nuclear chain reaction. The controller 50 is configured to control the nuclear chain reaction by adjusting the speed of the primary pump 4 by controlling the electric power delivered to the primary electric motor 5. In a molten salt reactor, adjusting the flow rate of the primary coolant indirectly influences the reactivity, assuming that the coolant temperature remains constant.

The controller 50 is configured to maintain the operating parameters of the nuclear reactor within a specified range or ranges, thereby allowing for the heat generated by the nuclear reactor core 2, at least during normal operation of the nuclear reactor, to be transferred by the internal as well as external heat exchange medium in the primary heat exchanger 10 and allows the nuclear fission chain reaction in the nuclear reactor to be regulated.

The controller 50 is configured to control the power output of the nuclear reactor core 2 as a function of the power being absorbed by the internal as well as external heat exchange medium in the heat exchanging arrangement, the function is preferably a function that ensures that the power output of the nuclear reactor core 2 is substantially equal to the power absorbed by the internal as well as external heat exchange medium in the heat exchanger 10.

The controller 50 is preferably configured to adjust the speed of the primary pump 4 as a function of the at least one thermodynamic condition of the primary heat exchange medium. The at least one thermodynamic condition preferably originates from one or more of the sensors arranged inside the vessel 1, e.g. a temperature sensor configured for sensing the temperature of the primary heat exchange medium, the function preferably comprising one or more of a proportional component, an integral component, a differential component, and /r the at least one controller 50 comprising a Model Predictive Controller.

The at least one thermodynamic condition of the primary heat exchange medium may comprise a temperature or a derivative thereof of the primary heat exchange medium sensed by a temperature sensor that is arranged in the interior.

The controller 50 is configured to maintain the temperature of the primary heat exchange medium at a specified temperature or within a specified temperature range as specified below. Preferably, the controller 50 is configured to adjust the primary pump speed to keep the fuel salt temperature at the fuel salt outlet 7 to approximately 700° C., preferably comprising decreasing primary pump speed to increase the fuel salt temperature at the fuel salt outlet 7, and increasing primary pump speed to decrease the fuel salt temperature at the fuel salt outlet 7.

The one controller 50 comprises one or more of: analog electronics, digital electronics, software for processing electronics values, mechanical logic, hydraulic and/or fluidic logic. The controller 50 preferably does not comprise an electronic digital programmable computer and preferably uses a redundant architecture, even more preferably a dissimilar redundant architecture.

The controller 50 can optionally be coupled to a transmitter 33 that is configured to send an uplink signal to a remote receiver, such as a remote server, thereby allowing the operation of the nuclear reactor to be remotely monitored. However, the transmitter 33 is as the name says only capable of transmitting data and is not capable of receiving data. Hereto, the controller is configured to send relevant data concerning the operation of the nuclear reactor to the transmitter 33.

In an embodiment the controller 50 uses an ‘air-gapped’ transmission to transmit data to a receiver outside the reactor vessel 1, to ensure that no data or instruction can be received by the controller 50 and to protect against an attacker trying to spoof the data uplink to gain access or control over the controller 50. Air-gapping is a security measure that involves isolating the controller 50 and preventing it from establishing an external connection. Thus, the controller 50 is physically segregated and incapable of connecting wirelessly or physically with other computers or network devices.

The consumer of heat 100 (or a human operator) can shut the reactor down by cutting off the supply of electric power 53 to the electric and electronic components in the reactor vessel 1, mainly as an emergency shutdown. Thereupon, the primary, secondary, and other heat exchange media will automatically drain to their respective drain tanks.

Alternatively, the consumer of heat 100 can shut the reactor down by stopping or ramping down the flow rate of the inside as well as outside heat exchange medium through conduit 23 to stop the reactor from producing heat. When the power requirement from the consumer of heat 100 drops below the decay heat produced during normal maximum operation (typically ˜5% of full power) the reactor will shut down to dispose of decay heat. Consequently, if the consumer of heat 100 ramps down to a consumption that is below the decay heat the reactor will stop the pumps 4,14,44 because not enough heat can be removed by the inside as well as outside heat exchange medium, and at least one of the salt (heat exchange medium) outlet temperatures will exceed their respective threshold. This is expected to be the most common way the consumer of heat 100 shuts down the reactor. This process will take several hours and may be initiated by the consumer of heat 100 e.g. for maintenance of the steam turbine 130,132.

The primary loop 3 is not pressurized, i.e. it operates with the primary heat exchange medium at substantially atmospheric pressure.

When at least one or a combination of the reactor parameters, e.g. in the form of thermodynamic conditions differs from the acceptable operating values or ranges (that are stored in advance and that the controller 50 has access to), the controller 50 will autonomously and without human intervention stop reactor operation. In some embodiments, the controller 50 will automatically stop the reactor operation by allowing the liquid to drain into the drain tank (17,48) under the influence of gravity. Examples of one or combination of reactor parameters differing from the acceptable operating values or ranges are the flow rate in the primary loop 3 being above an acceptable value or the fluid pressure in the primary loop or any other part of the system being in excess of an acceptable value. Other examples of one or a combination of reactor parameters differing from acceptable operating values are provided below.

FIG. 2 shows a second embodiment of the nuclear reactor. In this embodiment, structures, and features that are the same or similar to corresponding structures and features previously described or shown herein are denoted by the same reference numeral as previously used for simplicity. In this embodiment, the nuclear reactor comprises a secondary coolant loop 13 that is arranged inside the vessel 1. The secondary coolant loop passes through the primary heat exchanger 10 and exchanges heat with the internal as well as external heat exchange medium in a secondary heat exchanger 20. In this embodiment, the secondary heat exchange loop 13 comprises a secondary pump 14 for circulating a secondary heat exchange medium in the secondary heat exchange loop 13. The secondary pump 14 is a circulation pump that is driven by a secondary motor 15, which is preferably an electric motor. The secondary pump 14 is of an open type, e.g. a centrifugal type pump that is open for passage of primary heat exchange medium when the primary pump 14 is not operating (stopped). Thus, the secondary heat exchange medium will drain by the effect of gravity into the secondary exchange medium drain tank 27 when the secondary pump 14 is stopped, regardless of the cause of the secondary pump 14 being stopped, without the need for any flow control elements, such as valves or pumps to ensure passive safety. The secondary loop 23 is not pressurized, i.e. the secondary heat exchange medium is operated at a second substantially atmospheric pressure.

In this embodiment, the controller 50 is configured to regulate the speed of the secondary pump 14, with the primary aim to keep the temperature of the secondary heat exchange medium within a predetermined bandwidth or close to a predetermined set point. Preferably, the controller 50 is configured to adjusting secondary pump speed by adjusting the power to the secondary pump motor 15 to keep the fuel salt temperature at the fuel salt inlet 6 to approximately 600° C., preferably comprising increasing the secondary pump speed to decrease the temperature of the fuel salt at the fuel salt inlet 6 and decreasing secondary pump speed to increase the temperature of the fuel salt at the fuel salt inlet 6.

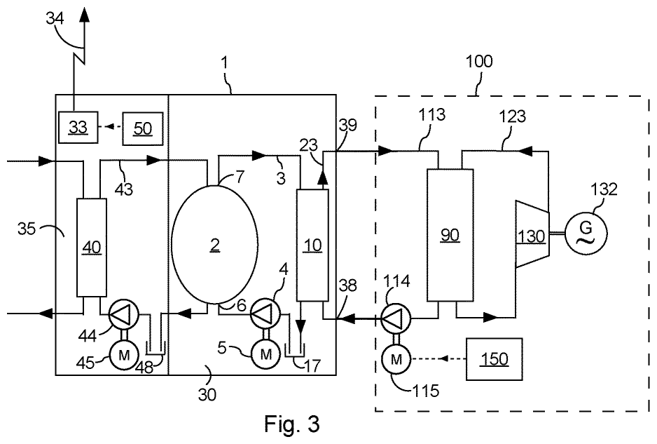

FIG. 3 shows a third embodiment of the nuclear reactor. In this embodiment, structures, and features that are the same or similar to corresponding structures and features previously described or shown herein are denoted by the same reference numeral as previously used for simplicity. In this embodiment, the nuclear reactor interior contains a liquid moderator loop 43. The liquid moderator loop 43 comprises a moderator pump 44 for circulating the liquid moderator in the moderator loop 43. The liquid moderator loop 43 passes through the nuclear reactor core 2, and preferably passes through a liquid moderator heat exchanger 40. The liquid moderator heat exchanger 40 exchanges heat with an inside as well as outside cooling medium, which is circulated through the liquid moderator heat exchanger and through a cooler (not shown) that is arranged exterior to the vessel 1.

In this embodiment the at least one at least one thermodynamic condition preferably comprises one or more of:
liquid moderator temperature at a position between a liquid moderator outlet of the liquid moderator heat exchanger 40 and a liquid moderator inlet of the nuclear reactor core 2,
liquid moderator temperature at a position between a liquid moderator outlet of the nuclear reactor core 2, and a liquid moderator inlet of the liquid moderator heat exchanger 40,
liquid moderator flow rate, the liquid moderator flow rate preferably being derived from the rotation speed of the tertiary pump 44.

The liquid moderator loop 43 is not pressurized, i.e. the liquid moderator is operated at a second substantially atmospheric pressure.

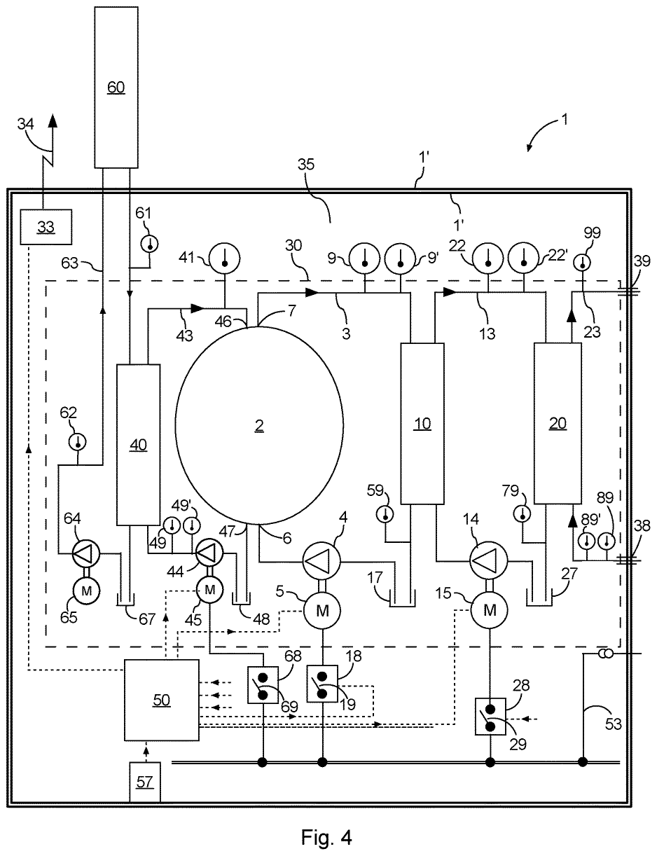

FIG. 4 illustrates a fourth embodiment in which the nuclear reactor is a molten salt nuclear reactor. In this embodiment, structures and features that are the same or similar to corresponding structures and features previously described or shown herein are denoted by the same reference numeral as previously used for simplicity. The molten salt nuclear reactor is arranged in the interior of a hermetically sealed vessel 1, also referred to as “reactor vessel”. The hermetically sealed vessel 1 forms an airtight housing in which the components of the molten salt nuclear reactor are located. In an embodiment, the reactor vessel 1 is a metal, preferably steel casing, i.e. a casing with metal or steel walls. In an embodiment, the reactor vessel 1 is provided with two layers of airtightness, i.e. double walled vessel, as illustrated by the reactor vessel 1 having an inner wall 1′ surrounded by an outer wall 1″ in FIG. 1.

The interior of the reactor vessel 1 is in an embodiment divided into a hot area 30, sometimes referred to as furnace, and a cool area 35. The interior of the vessel 1 contains a nuclear reactor core 2, preferably in the hot area 30, and at least one salt loop 3, 13, preferably in the hot area 30. In the present embodiment, a liquid moderator loop 43 is contained in the interior of the vessel 1, preferably in the hot area.

The nuclear reactor will have at least a fuel salt loop 3 (primary loop), and optionally one or more cooling salt loops 13 (secondary and tertiary loops). Each salt loop 3, 13 comprises a pump 4, 14 for circulating a molten salt in the salt loop 3, 13 concerned. Each salt loop 3, 13 contains a molten salt or a molten salt mixture with suitable properties, e.g. a fluoride or chloride salt. An example of a suitable salt for the molten salt loop is FLiBe (a mixture of lithium fluoride (LiF) and beryllium fluoride (BeF2).

The fuel salt loop 3 extends through the nuclear reactor core 2, and accordingly, the nuclear reactor core 2 is provided with a fuel salt inlet 6 and a fuel salt outlet 7 that connect the portion of the fuel salt loop 3 that extends through the nuclear reactor core 2. The fuel salt comprises fissile components, preferably comprising enriched lithium 7 fluoride, thorium tetrafluoride, uranium tetrafluoride, uranium trifluoride and/or plutonium trifluoride 7LiF-ThF4-UF4-UF3-PuF3 salt. The fuel salt loop 3 passes through a first heat exchanger 10 for exchanging heat with the primary coolant salt and through a fuel salt drain tank 17 which forms the lowest part of the fuel salt loop 3. The fuel salt pump 4 pumps the fuel salt up from the fuel salt drain tank 17. The fuel salt pump 4 is driven by a primary electric motor 5 and the fuel salt pump 4 is of an open type, e.g. a centrifugal type pump that is open for passage of the fuel salt when the fuel salt pump 4 is not operating. Thus, the fuel salt drains by the effect of gravity into the fuel salt drain tank 17 when the fuel salt pump 4 is stopped, without the need for any flow control elements, such as valves or pumps.

One of the optional cooling salt loops, is a primary cooling salt loop 13, which extends through the first heat exchanger 10 for exchanging heat with the fuel salt, through a second heat exchanger 20 for exchanging heat with an internal as well as external heat exchange medium and through a primary cooling salt drain tank 27 that forms the lowest part of the primary cooling salt loop 13. The primary cooling salt pump 14 pumps the primary cooling salt up from the primary cooling salt drain tank 27. The primary cooling salt pump 14 is driven by a secondary electric motor 15 and the primary cooling salt pump 14 is of an open type, e.g. a centrifugal type pump that is open for passage of the primary cooling salt when the primary cooling salt pump 14 is not operating. Thus, the fuel salt drains by the effect of gravity into the primary cooling salt drain tank 27 when the primary cooling salt pump 14 is stopped, without the need for any flow control elements, such as valves or pumps. The primary cooling salt loop 13 is not pressurized, i.e. the primary cooling salt is operated at substantially atmospheric pressure.

A liquid moderator loop 43 extends through the nuclear reactor core 2, and accordingly, the nuclear reactor core 2 is provided with a liquid moderator inlet 46 and a liquid moderator outlet 47 that connect the portion of the liquid moderator loop 43 that extends through the nuclear reactor core 2. The liquid moderator loop 43 comprises a moderator pump 44 for circulating the liquid moderator in the moderator loop 43. The liquid moderator comprises in an embodiment heavy water or a molten hydroxide, preferably molten enriched lithium 7 deuteroxide salt (7LiOD). The liquid moderator loop passes through a liquid third heat exchanger 40 for the liquid moderator to exchange heat with a liquid moderator cooling medium. The liquid moderator loop 43 extends through a liquid moderator drain tank 48 that forms the lowest part of the liquid loop 43. The tertiary pump 44 pumps the liquid moderator up from the liquid moderator drain tank 48. The tertiary pump 44 is a circulation pump driven by a tertiary electric motor 45 and is of an open type, e.g. a centrifugal type pump that is open for passage of the liquid moderator salt when the tertiary 44 is not operating. Thus, the liquid moderator by the effect of gravity into the liquid moderator drain tank 48 when the tertiary pump 44 is stopped, without the need for any flow control elements, such as valves or pumps. The tertiary pump is driven by a tertiary electric motor 45.

The liquid moderator cooling medium circulates in a liquid moderator cooling medium loop 63. The liquid moderator cooling medium loop 63 comprises a liquid moderator cooling medium pump 64 driven by a quaternary electric motor 65 for circulating the liquid moderator, a liquid moderator cooling medium drain tank 67 and a liquid moderator cooling medium cooler 60. The liquid moderator cooler 60 is preferably arranged outside the reactor vessel 1. The liquid moderator cooling medium drain tank 67 forms the lowest part of the liquid moderator cooling medium loop 63. The liquid moderator cooling medium pump 64 is a circulation pump that is driven by quaternary motor 65 and the liquid moderator cooling medium pump 64 is of an open type, e.g. a centrifugal type pump that is open for passage of the liquid moderato when the liquid moderator cooling medium pump 64 is not operating. Thus, the liquid moderator cooling medium drains by the effect of gravity into the liquid moderator drain tank 48 when the liquid moderator cooling medium pump 64 is stopped, without the need of any flow control elements, such as valves or pumps.

A heat exchange medium conduit 23 for removing heat from the interior of the reactor vessel 1 is arranged in the interior of the reactor vessel 1. An internal as well as external heat exchange medium is flowed through the conduit 23 for exchanging heat in the second heat exchanger 20 with the primary cooling salt. In an embodiment, the internal as well as external heat exchange medium is a molten nitrate salt, but it could also be another type of salt, or another type of suitable liquid or gas, or vapor. The internal as well as external heat exchange medium is pumped through the heat exchange medium conduit 23 and thus through the second heat exchanger 20 to remove the heat produced in the fuel salt and convey this heat to a consumer of heat. The internal as well as external heat exchange medium conduit 23 fluidically connects a heat exchange medium inlet 38 with a heat exchange medium outlet 39. Both the heat exchange medium inlet 38 and the heat exchange medium outlet 39 open to the exterior of the vessel 1 for connecting to an exterior consumer of heat as described with reference to FIGS. 1 to 3 above.

The fuel salt loop 3 is provided with a temperature sensor 9 for sensing the temperature of the fuel salt leaving the reactor core 2, together with a second temperature sensor 9′ for redundancy. The signal of the sensors 9,9′ is communicated to the controller 50. The fuel salt loop 3 can also be provided with a temperature sensor 59 for sensing the temperature of the fuel salt going into the reactor core 2. The signal of the sensor is communicated to the controller 50.

The cooling salt loop 13 is provided with a temperature sensor 22 for sensing the temperature of the cooling salt leaving the first heat exchanger 10, together with a second temperature sensor 22′ for redundancy. The signal of the sensors is communicated to the controller 50. The cooling salt loop 23 can also be provided with a temperature sensor 79 for sensing the temperature of the cooling salt going into the first heat exchanger 10. The signal of the sensor is communicated to the controller 50.

Similarly, the moderator loop is provided with a pair of temperature sensors 49, 49′ for sensing the temperature of the liquid moderator leaving the reactor core 2, and with another temperature sensor 41 for sensing the temperature of the liquid moderator going into the reactor core 2. The signal of the sensors is communicated to the controller 50.

The liquid moderator cooling loop is provided with a temperature sensor 62 for sensing the temperature of the moderator cooling medium leaving the liquid moderator heat exchanger 40 and with a temperature sensor 61 for sensing the temperature of the liquid moderator cooling medium entering the liquid moderator heat exchanger 40.

The conduit 23 for the inside as well as outside the exchange medium is provided with a pair of temperature sensors 89, 89′ for sensing the temperature of the internal as well as external heat exchange medium entering the conduit 23 through the inlet opening 38 and with a temperature sensor 99 for sensing the temperature of the inside as well as outside heat exchange medium leaving the conduit through outlet 39.

The above-mentioned temperature sensors can e.g. be implemented in the form of thermocouples or thermo-switch. If the temperature sensor is a thermocouple it generates a signal representative of the temperature that is sensed. For temperatures that are critical information, there will be two or more sensors for providing redundancy. If the temperature sensor is a thermo-switch it generates either a closed or open circuit, that can have a predetermined and hardwired temperature at which forms an open circuit that can e.g. be used to trip a breaker circuit. The thermo-switch can e.g. use a bimetallic strip or differential thermal expansion to trigger when a threshold temperature is reached with high reliability.

In an embodiment, a seismic sensor 57 is arranged in the interior 30,35 of the reactor vessel 1. the signal of the seismic sensor 57 is communicated to the controller 50, to allow the controller 50 to safely shut down the operation of the nuclear reactor when seismic events that exceed a predetermined level are sensed by the sensor 57.

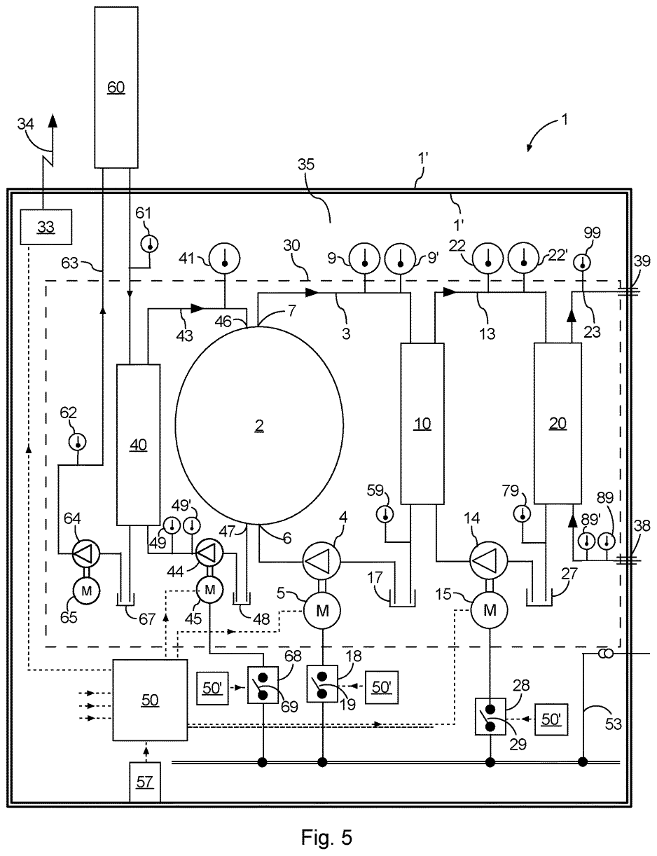

FIG. 5 shows a fifth embodiment of the nuclear reactor. In this embodiment, structures, and features that are the same or similar to corresponding structures and features previously described or shown herein are denoted by the same reference numeral as previously used for simplicity. This embodiment is essentially identical to the embodiment of FIG. 4, except that the circuit breaker arrangements 19,29,69 have a dedicated controller 50′, and the controller 50 is not used to control the circuit breaker arrangements 16,29,69.

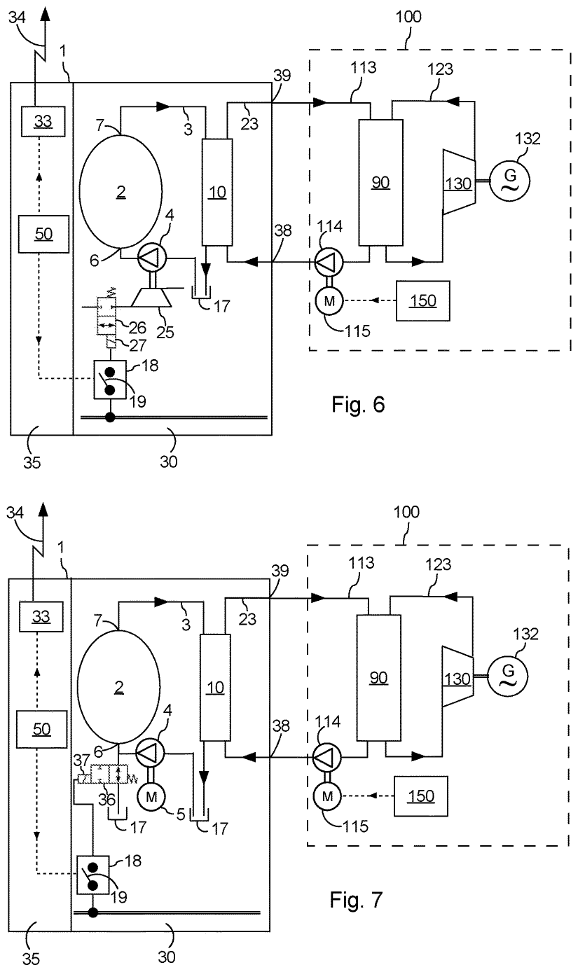

FIG. 6 shows a sixth embodiment of the nuclear reactor. In this embodiment, structures, and features that are the same or similar to corresponding structures and features previously described or shown herein are denoted by the same reference numeral as previously used for simplicity. This embodiment is essentially identical to the embodiment of FIG. 1, except that the primary pump 4 is driven by a turbine 25 or other fluidically driven motor, and a breaker circuit arrangement 18 comprising a circuit breaker 19 is operably connected to a normally closed valve 26. The normally closed valve 26 is arranged in a supply conduit that supplies the turbine 25 with fluidic power (hydraulic or pneumatic power) and the normally closed valve 26 is moved to its open position (in which the normally closed valve 26 allows fluidic power to the turbine 25) by an electric actuator (e.g. solenoid) 27 and moves to its closed position (where the normally closed valve 26 does not allow fluidic power to the turbine 25) by e.g. a resilient element. The circuit breaker arrangement 28 is connected to the controller 50 and configured to trip the circuit breaker 19 upon receiving this signal to do so from the controller 50. Thus, when the circuit breaker 29 is tripped (to its open position), the electronic actuator is no longer powered and the normally closed valve 26 closes under the influence of the resilient element and the turbine 25 does not receive fluid power, and the primary pump 4 stops. This will allow the primary heat exchange medium to drain to the drain tank 17 and the nuclear reaction in the core 2 stops.

FIG. 7 shows a seventh embodiment of the nuclear reactor. In this embodiment, structures, and features that are the same or similar to corresponding structures and features previously described or shown herein are denoted by the same reference numeral as previously used for simplicity. This embodiment is essentially identical to the embodiment of FIG. 1, except that the primary heat exchange circuit 3 is connected at a suitable (i.e. relatively low) position to a drain conduit that leads to the drain tank 17. A normally open valve 36 is arranged in the drain conduit. The normally open valve 36 is moved to its closed position by an electric actuator (e.g. a solenoid) 37 and the normally open valve 36 moves to its open position (e.g. under the influence of a resilient element) when the electric actuator 37 is not powered. The electric actuator 37 receives electric power through a circuit breaker arrangement 18 that comprises a circuit breaker 19. The circuit breaker arrangement 18 is connected to the controller 50 and the circuit breaker arrangement 18 is configured to trip the circuit breaker 19 to its open position upon receiving a signal to do so from the controller 50. Thus, when the circuit breaker arrangement 18 receives a signal from the controller 50 to stop the operation of the nuclear reactor 1, the circuit breaker 19 is tripped to its open position, thereby cutting off electric power to the electric actuator 37, which causes the normally open valve 36 to move to its open position, thereby allowing the primary heat exchange medium to drain from the primary exchange circuit 3 to the train tank 17, which causes the nuclear reaction in the nuclear reactor core 2 to stop.

In an embodiment, a radiation level sensor (not shown) for generating a signal representative of a radiation level in the interior of the reactor vessel 1 is arranged in the interior of the reactor vessel 1.

In an embodiment, a sensor is configured for issuing a signal indicative of the open and/or closed position of a door (not shown) in the reactor vessel 1 for giving access to the interior (30,35).

In an embodiment, one or more of the salt loops 3, 13, the moderator loop 43, and the heat exchange conduit 23 are provided with a leak sensor (not shown) configured to issue a leak signal when a leak occurs.

The controller 50 is arranged in the interior of the reactor vessel 1, preferably in the cool area 35. The controller 50 is in an embodiment a distributed controller, i.e. it is composed of several interconnected controllers that can be physically arranged in different locations. The controller 50 does not receive any data or signals from the exterior of the reactor vessel 1 and operates/relies preferably exclusively on the basis of data that is generated inside the reactor vessel 1. The data that is generated inside the reactor vessel 1 originates, at least in part, from sensors that are arranged inside the reactor vessel 1. The controller 50 is in receipt of a signal from the sensors that are arranged inside the reactor vessel 1.

The controller 50 is configured to control the speed of the primary, secondary, tertiary, and quaternary electric motor 5, 15, 45, 65 through a signal to the drive associated with the respective electric motor. The controller 50 is also configured to start and end the operation of the primary, secondary, tertiary, and quaternary pumps, 5, 15, 45, 65.

Additionally, the controller 50 can be configured to control the secondary, tertiary, and quaternary electric motors 15, 45, 65 for adjusting the speed of the secondary pump 14, the tertiary pump 44, and the tertiary pump 65. The controller 50 is also configured to start and end the operation of the primary, secondary, tertiary, and quaternary pumps, 5, 15, 45, 65.

The fuel salt loop 3 provides fuel salt to the reactor core 2 for driving and controlling the nuclear reaction. The optional moderator loop provides liquid moderator to the reactor core 2 for controlling the nuclear reaction.

The controller 50 is configured to autonomously and without human intervention control the operation of the nuclear reactor relying preferably exclusively on data originating inside the vessel 1. At least some of the data originating inside the vessel 1 originate from one or more sensors arranged inside the vessel 1. The data originating from within the vessel 1 preferably comprises at least one thermodynamic condition of the primary heat exchange medium.

The at least one thermodynamic condition may comprise one or more of:
fuel salt temperature or a derivative thereof at a position between an outlet of the primary heat exchanger 10 and a fuel salt inlet 6 of the nuclear reactor core 2,
fuel salt temperature or a derivative thereof at a position between a fuel salt outlet 7 of the nuclear reactor core 2 and an inlet of the primary heat exchanger 10,
fuel salt flow rate, the fuel salt flow rate preferably being derived from the rotation speed of the primary pump 4,
primary cooling salt temperature or a derivative thereof at a position between an outlet of the secondary heat exchanger 20 and a primary cooling salt inlet of the primary heat exchanger 10,
primary cooling salt temperature or a derivative thereof at a position between a primary cooling salt outlet of the primary heat exchanger 10 and an inlet of the secondary heat exchanger 20,
primary cooling salt flow rate, the primary cooling salt flow rate preferably being derived from the rotation speed of the secondary pump 14,
liquid moderator temperature at a position between a liquid moderator outlet of the liquid moderator heat exchanger 40 and a liquid moderator inlet of the nuclear reactor core 2,
liquid moderator temperature at a position between a liquid moderator outlet of the nuclear reactor core 2, and a liquid moderator inlet of the liquid moderator heat exchanger 40,
liquid moderator flow rate, the liquid moderator flow rate preferably being derived from the rotation speed of the tertiary pump 44.

The controller 50 is configured to provide an output value, the output value comprising one or more of:
speed of the primary pump 4,
speed of a secondary pump 14,
speed of a tertiary pump 44,
speed of a quaternary pump 64,
speed of a blanket salt pump,
ending operation of the primary pump 4,
ending operation of a secondary pump 14,
ending operation of a tertiary pump 44,
ending operation of a quaternary pump 64,
ending operation of a blanket salt pump,
starting operation of the primary pump 4,
starting operation of a secondary pump 14,
starting operation of a tertiary pump 44,
starting operation of a quaternary pump 64,
starting operation of a blanket salt pump.

The controller 50 is configured to perform one or more of:
adjusting primary pump speed to keep the fuel salt temperature at the fuel salt outlet 7 to approximately 700° C., preferably comprising decreasing primary pump speed to increase the fuel salt temperature at the fuel salt outlet 7, and increasing primary pump speed to decrease the fuel salt temperature at the fuel salt outlet 7,
adjusting a tertiary pump speed, which adjusts the liquid moderator level in the nuclear reactor core 2 and thus the reactivity, to keep the average temperature between the fuel salt inlet 6 and fuel salt outlet 7 to approximately 650° C., preferably comprising increasing moderator pump speed to increase reactivity and decreasing moderator pump speed to decrease reactivity,
adjusting secondary pump speed to keep the fuel salt temperature at the fuel salt inlet 6 to approximately 600° C., preferably comprising increasing the secondary pump speed to decrease the temperature of the fuel salt at the fuel salt inlet 6 and decreasing secondary pump speed to increase the temperature of the fuel salt at the fuel salt inlet 6,
adjusting moderator coolant pump speed to keep the temperature of the liquid moderator at the liquid moderator outlet of the nuclear reactor core 2 at approximately 40° C., preferably comprising increasing tertiary pump speed to decrease the temperature of the liquid moderator at the liquid moderator outlet of the nuclear reactor core 2, and decreasing tertiary speed to increase the temperature of the liquid moderator at the liquid moderator outlet of the nuclear reactor core 2.

In an embodiment, the controller 50 is configured to control the level of moderation in the nuclear reactor core 2 as a function of the data originating from within the vessel 1. hereto, the controller adjusts the level (amount) of liquid moderator in the nuclear reactor core 2. The level of liquid moderator and the reactor core can be adjusted by adjusting the speed of the moderator pump 44, with a higher speed resulting in a higher level of moderator in the reactor core and a lower speed resulting in a lower level of liquid moderator in the nuclear reactor core. This can be achieved, e.g. by allowing the liquid moderator to drain passively back into the liquid moderator drain tank 48 and having a separate gas connecting between the gas head volume of the liquid moderator tanks in the core 2 and the gas head of the liquid moderator tanks 48 the gas pressures above the liquid levels will be the same. Thus, the draining flow rate of the liquid moderator in the core will be proportional to the liquid moderator height in the core 2 and will converge on to the flow rate of the tertiary pump 44. A tuned flow restriction at or downstream of the liquid moderator outlet 47 allows for the desired relationship between liquid moderator level and tertiary pump flow rate or speed.

The nuclear reactor, comprises in an embodiment a breaker circuit arrangement 18,28,68 controlled by the controller 50 (a portion of the controller 50 can be arranged to be a part of the breaker circuit arrangement 18,28,68) and configured to connect and disconnect at least one of the electric and/or electronic components 4,14,44 in the interior of the vessel 1 to and from a source of electric power 53 inside the vessel 1. The breaker circuit arrangement 18,28,68 is connected to the at least one sensor 9,22,41,49,59,79 that provides a signal representative of an operating condition of the nuclear reactor. The breaker circuit arrangement 18,28,68 is configured to open one or more or all circuit breakers 19,29,69 when the signal from the sensor 9,22,41,49,59,79 exceeds a safety threshold, preferably a safety threshold that indicates that the nuclear reactor is operated in an undo manner, a failure of a critical component has occurred, or another safety critical criterium has been exceeded.

In an embodiment, the breaker circuit arrangement 18,28,68 comprises a circuit breaker 19,29,69 controlled by one of the controllers 50. The nuclear reactor is configured to end the nuclear reaction and enter a safe state upon disconnecting the at least one of the electric and/or electronic components 5,15,45,65 in the interior of the vessel 1 from the source of electric power 53. Thus, deactivating the electric power supply 53 will stop the operation of the nuclear reactor safely. As mentioned above, the liquid loops 3,13,43 in the interior are drained by gravity to their respective drain tanks 17, 27, and 48, and the nuclear reaction will stop. Preferably the process of draining the liquid from the loops is passive, i.e. under the influence of gravity only.

The controller 50 is configured to start the operation of the nuclear reactor by connecting the electric and/or electronic components 5,15,45 to the source of electric power 53 by switching the breaker circuit arrangement 18,28,68 from an open position to a closed position. The controller 50 is configured to end the operation of the nuclear reactor by disconnecting the electric and/or electronic components 4,14,44,65 to the source of electric power 53 by switching the breaker circuit arrangement 18,28,68 from a closed position to an open position.

Each breaker circuit arrangement 18,28,68 comprises a circuit breaker 19,29,69 and one of the at least one (portion of) the controller 50. The controller 50 preferably comprises analog electronics and/or digital electronics that are configured to operate the respective circuit breaker 19,29,69 as either open or closed, the controller 50 preferably not comprising an electronic digital programmable computer.

The controller 50 is configured to autonomously and without human intervention and automatically stop the reactor operation by allowing the liquid to drain into the drain tank 17,48 under the influence of gravity, e.g. by opening a circuit breaker thus allowing the heat exchange liquids to drain into the respective drain tanks 17,27,48,67 under the influence of gravity when at least one or a combination of the reactor parameters, e.g. in the form of thermodynamic conditions differs from the acceptable operating values or ranges. Examples of acceptable operating values are (non-exhaustive list):
door to reactor vessel 1 closed (on, otherwise reactor shutdown)
leak detection sensors showing no leaks (on, otherwise reactor shutdown)
radiation detector below threshold (on, otherwise reactor shutdown)
first derivative of radiation detector below threshold (on, otherwise reactor shutdown)
reactor vessel furnace between 580° C. and 720° C. (on, otherwise reactor shutdown)
fuel salt inlet temperature between 580° C. and 720° C. (on, otherwise reactor shutdown)
fuel salt inlet temperature between 580° C. and 720° C. (on, otherwise reactor shutdown)
first coolant salt inlet temperature between 480° C. and 720° C. (on, otherwise reactor shutdown)
first coolant salt inlet temperature between 480° C. and 720° C. (on, otherwise reactor shutdown)
second coolant salt inlet temperature between 300° C. and 580° C. (on, otherwise reactor shutdown)
second coolant salt inlet temperature between 300° C. and 580° C. (on, otherwise reactor shutdown)
blanket salt inlet temperature between 580° C. and 720° C. (on, otherwise reactor shutdown)
blanket salt inlet temperature between 580° C. and 720° C. (on, otherwise reactor shutdown)
scrubber salt inlet temperature between 580° C. and 720° C. (on, otherwise reactor shutdown)
scrubber salt inlet temperature between 580° C. and 720° C. (on, otherwise reactor shutdown)
liquid moderator inlet temperature between 5° C. and 90° C. (on, otherwise reactor shutdown)
liquid moderator temperature between 5° C. and 90° C. (on, otherwise reactor shutdown)
liquid moderator coolant inlet temperature between 5° C. and 90° C. (on, otherwise reactor shutdown)
liquid moderator coolant inlet temperature between 5° C. and 90° C. (on, otherwise reactor shutdown)
speed of primary pump 4 below a predetermined threshold (on otherwise reactor shutdown),
flow rate of primary heat exchange medium below a predetermined threshold (on otherwise reactor shutdown),
pressure of primary heat exchange medium below a predetermined threshold (on otherwise reactor shutdown).

In an embodiment, the nuclear reactor is configured to end the nuclear reaction and enter a safe state upon disconnecting the at least one of the electric and/or electronic components 5,15,45 in the interior from the source of electric power 53. In an embodiment, the nuclear reactor is configured to start operation when the electric and/or electronic components 5,15,45 are connected to the source of electric power 53, preferably by switching the circuit breaker 19, 29, 69 of the breaker circuit arrangement 18,28,68 from an open position to a closed position.

In an embodiment, the nuclear reactor is configured to end operation by disconnecting the at least one of the electric and/or electronic components 5,15,45 to the source of electric power by switching the circuit breaker 19,29,69 of the breaker circuit arrangement 18,28,68 from an open position to a closed position.

In an embodiment, the breaker circuit arrangement 18,28,68 is configured to require a safety threshold to be exceeded for a predetermined amount of time before switching a circuit breaker 19, 29, 69 to the open position, so that a transient outside of the safety threshold values of a few seconds does not trip the circuit breaker 19,29,69.

In an embodiment, the breaker circuit arrangement 18,28,68 is configured to use the first or second derivative of a signal from a one sensor 9,22,41,49,59,79, in addition, or instead of the value of the signal itself, for determining if a safety threshold has been exceeded.

In an embodiment, the procedure for starting up the nuclear reactor comprises connecting the controller 50 to the source of electrical power 53. Thereupon, the controller 50 starts heating the molten salt(s) electrically to reach a lower temperature threshold limit of the salt(s) and starts the pump(s) 4,14,44 when the salt(s) have reached sufficient temperature. If the restart occurs after a shutdown where the power was kept on and the salt(s) cools down over a longer period (hours or days) and gets below the lower threshold limits the heaters start heating again (of course assuming that the power is still connected), in order to prevent freezing of the salt(s). After a shutdown where the power was disconnected and the salt(s) cools down below threshold limits, once power is turned back on the controller 50 starts heating the salt(s) with the heaters to reach the minimum temperature limits as if it was the first time that the nuclear reactor is turned on, oblivious to the earlier shutdown, the controller 50 only taking into account predefined targets. Preferably, thresholds are set that do not allow the controller 50 to initiate a restart in certain scenarios, e.g. when the power to the reactor has been turned off and the salt has reached 900° C. and a mechanical thermo-switch (a switch that does not require electric power) is triggered. After such an event the reactor cannot be restarted because a limit at which is not deemed to be safe to restart has been reached. Similarly, in an embodiment, there is provided a thermo-switch to detect that the salt(s) have cooled down to below the melting point of the salt(s) since salt freezing could damage components. Another similar scenario relates to the detection of a leak by leak detection sensors, that once triggered to not allow the reactor to be turned on again. Preferably, the leak detection sensor is configured to operate without power, or with batteries, or by still capable of sensing a leak even after power is turned off and on.

Preferably, the nuclear reactor has a negative fuel reactivity coefficient, negative moderator reactivity coefficient (if present), and negative blanket reactivity coefficient (if present), to ensure stable power operation of the reactor core. Preferably, the nuclear reactor has a passive decay heat removal system.

In an embodiment, the fuel salt comprises fissile components, preferably comprising enriched lithium 7 fluoride, uranium tetrafluoride, low enriched uranium trifluoride (7LiF)-(UF4)-(UF3) salt.

In an embodiment, the nuclear reactor core 2 comprises a blanket (not shown) containing blanket salt, preferably, the blanket is connected to a blanket salt loop. The blanket salt is in an embodiment a molten salt comprising fertile components, preferably comprising enriched lithium 7 fluoride and/or thorium tetrafluoride (7LiF-ThF4) salt.

In an embodiment, electric power for sensors and electronics is behind the breaker circuit arrangement 18,28,68, so that the sensors and electronics remain operational when the circuit breaker 19,29,69 opens and cuts power to all electronic and electric components behind the breaker circular arrangement 18,28,68.

In an embodiment, the nuclear reactor operates according to an inherently safe process that directly provides a passive safety component during a specific failure condition in all operational modes.

In an embodiment, the nuclear reactor does not require any active intervention on the part of an operator or electrical/electronic feedback in order to bring the reactor to a safe shutdown state.

In an embodiment, the nuclear reactor is inherently safe, and preferably does not rely on active systems for ensuring reactor safety.

The various aspects and implementations have been described in conjunction with various embodiments herein. However, other variations to the disclosed embodiments can be understood and effected by those skilled in the art in practicing the claimed subject-matter, from a study of the drawings, the disclosure, and the appended claims. In the claims, the word “comprising” does not exclude other elements or steps, and the indefinite article “a” or “an” does not exclude a plurality. A single processor, controller or other unit may fulfill the functions of several items recited in the claims. The mere fact that certain measures are recited in mutually different dependent claims does not indicate that a combination of these measures cannot be used to advantage.

The reference signs used in the claims shall not be construed as limiting the scope. Unless otherwise indicated, the drawings are intended to be read (e.g., cross-hatching, arrangement of parts, proportion, degree, etc.) together with the specification, and are to be considered a portion of the entire written description of this disclosure.

1. A nuclear reactor for maintaining a sustained nuclear fission chain reaction, the nuclear reactor comprising a closed and preferably leaktight vessel (1), the vessel (1) having an interior (30,35), the interior (30,35) of the vessel (1) containing:
a nuclear reactor core (2) of the nuclear reactor, the nuclear reactor core (2) having a power output during the sustained nuclear fission chain reaction,
at least a primary heat exchange loop (3) of the nuclear reactor, the at least a primary heat exchange loop (3) comprising a primary heat exchange medium pump (4) for circulating a primary heat exchange medium in the primary heat exchange loop (3), a conduit (23) of the nuclear reactor,
conduit (23) being configured for transporting an internal as well as external heat exchange medium, the conduit (23) fluidically connecting an inlet (38) of the nuclear reactor with an outlet (39) of the nuclear reactor,
the inlet (38) penetrates the exterior of the vessel (1), and the outlet (39) penetrates the exterior of the vessel (1),
a heat exchanging arrangement of the nuclear reactor, the heat exchanging arrangement being configured for exchanging heat between the primary heat exchange medium and the internal as well as external heat exchange medium, and
characterized in that the vessel (1) contains:
at least one controller (50) of the nuclear reactor, the controller (50) being configured to autonomously control the operation of the nuclear reactor, including the power output of the nuclear reactor core (2) by adjusting the sustained nuclear fission chain reaction, relying on data originating inside the vessel (1), and in that
at least some of the data originating inside the vessel (1) originates from one or more sensors of the nuclear reactor that are arranged inside the vessel (1), the data originating from within the vessel (1) comprising at least one thermodynamic condition of the primary heat exchange medium.

2. The nuclear reactor according to claim 1, wherein the reactivity of the nuclear reactor is controlled with closed loop control with a sensed process variable being a thermodynamic condition of the primary heat exchange medium or radiation level of the reactor core (2) sensed by a sensor inside the vessel (1) and communicated to the at least one controller (50).

3. The nuclear reactor according to claim 1, wherein the at least one controller (50) is configured to maintain operating parameters of the nuclear reactor within a specified range or ranges, thereby allowing for the heat generated by the nuclear reactor core (2), at least during normal operation of the nuclear reactor, to be transferred by the internal as well as external heat exchange medium in the heat exchanging arrangement and/or allowing the nuclear fission chain reaction in the nuclear reactor to be regulated.

4. The nuclear reactor according to claim 1, wherein the at least one controller (50) is configured to control power output of the nuclear reactor core (2) by adjusting the sustained nuclear fission chain reaction by adjusting the level of fission inducing neutrons in the reactor core (2).

5. The nuclear reactor according to claim 1, wherein the at least one controller (50) is configured to control the power output of the nuclear reactor core (2) as a function of the power being absorbed by the internal as well as external heat exchange medium in the heat exchanging arrangement, the function preferably being a function that ensures that the power output of the nuclear reactor core (2) is substantially equal to the power being absorbed by the internal as well as external heat exchange medium in the heat exchanging arrangement.

6. The nuclear reactor according to claim 1, wherein the at least one controller (50) is configured to maintain the temperature of the primary heat exchange medium at a specified temperature or within a specified temperature range.

7. The nuclear reactor according to claim 1, wherein the at least one controller (50) is configured to adjust the speed of the primary heat exchange pump (4), preferably as a function of the at least one thermodynamic condition of the primary heat exchange medium, the at least one thermodynamic condition preferably originating from one or more of the sensors arranged inside the vessel (1), the function preferably comprising one or more of a proportional component, an integral component, a differential component, and /or the at least one controller (50) comprising a Model Predictive Controller.

8. The nuclear reactor according to claim 1, wherein the at least one thermodynamic condition of the primary heat exchange medium comprises a temperature or a derivative thereof of the primary heat exchange medium sensed by a temperature sensor (9,9′) that is arranged in the interior.

9. The nuclear reactor according to claim 1, wherein the at least one controller (50) comprises one or more of analog electronics, digital electronics, software for processing electronics values, mechanical logic, hydraulic and/or fluidic logic preferably using a redundant architecture, even more preferable using a dissimilar redundant architecture.

10. The nuclear reactor according to claim 1, comprising a breaker circuit arrangement (18,28,68) configured to connect and disconnect at least one electric and/or electronic component (5,15,45) in the interior to and from a source of electric power (53) inside the vessel (1), the breaker circuit arrangement (18,28,68), preferably comprising a circuit breaker (19,29,69) controlled by one of the at least one the controller (50), the nuclear reactor being preferably being configured to end the nuclear reaction and enter a safe state upon disconnecting the at least one of the electric and/or electronic components (5,15,45) in the interior from the source of electric power (53).

11. The nuclear reactor according to claim 10, wherein the at least one controller (50) is configured to start operation of the nuclear reactor by connecting the electric and/or electronic components (5,15,45) to the source of electric power (53) by switching the breaker circuit arrangement (18,28,68) from an open position to a closed position.

12. The nuclear reactor according to claim 10, wherein the at least one controller (50) is configured to end operation of the nuclear reactor by connecting the electric and/or electronic components (5,15,45) to the source of electric power (53) by switching the breaker circuit arrangement (18,28,68) from an open position to a closed position.

13. The nuclear reactor according to claim 10, wherein the breaker circuit (18,28,68) arrangement comprises a circuit breaker (19,29,69) and one of the at least one controller (50), the one of the at least one controller (50) preferably comprising analog electronics and/or digital electronics that are configured to operate of the circuit breaker (19,29,69) as either open or closed, the one of the at least one controller (50) preferably not comprising an electronic digital programmable computer.

14. The nuclear reactor according to claim 1, wherein the nuclear reactor is a molten salt nuclear reactor, the primary heat exchange medium is a fuel salt comprising fissile material, the primary heat exchange medium loop (3) is a fuel salt loop (3), the primary heat exchange medium pump (4) is a fuel salt pump (4), the heat exchanging arrangement comprises a primary heat exchanger (10), the primary heat exchange loop (3) passes through the primary heat exchanger, and wherein the at least one thermodynamic condition preferably comprises one or more of:
fuel salt temperature or a derivative thereof at a position between an outlet of the primary heat exchanger (10) and a fuel salt inlet (6) of the nuclear reactor core (2),
fuel salt temperature or a derivative thereof at a position between a fuel salt outlet (7) of the nuclear reactor core (2) and an inlet of the primary heat exchanger (10),
fuel salt flow rate, the fuel salt flow rate preferably being derived from the rotation speed of the primary pump (4).

15. The nuclear reactor according to claim 14, wherein the interior contains a primary cooling salt loop (13) of the nuclear reactor, the primary cooling salt loop (13) passing through the primary heat exchanger (10) for exchanging heat with the fuel salt and through a secondary heat exchanger (20) of the nuclear reactor preferably for exchanging heat with the internal as well as external heat exchange medium, the primary cooling salt loop (13) comprising a secondary pump (14) for circulating the primary cooling salt in the primary cooling salt loop (13), and wherein the at least one thermodynamic condition preferably comprises one or more of:
primary cooling salt temperature or a derivative thereof at a position between an outlet of the secondary heat exchanger (20) and a primary cooling salt inlet of the primary heat exchanger (10),
primary cooling salt temperature or a derivative thereof at a position between a primary cooling salt outlet of the primary heat exchanger (10) and an inlet of the secondary heat exchanger (20),
primary cooling salt flow rate, the primary cooling salt flow rate preferably being derived from the rotation speed of the secondary pump (14).

16. The nuclear reactor according to claim 1, wherein the interior contains a moderator arrangement (43, 44) of the nuclear reactor, the moderator arrangement (43, 44) being configured for adjusting the level of moderation in the nuclear reactor core (2), and wherein the at least one controller (50) is configured to control the level of moderation in the nuclear reactor core (2) as a function of the data originating from within the vessel (1).

17. The nuclear reactor according to claim 14, wherein the interior contains a liquid moderator loop (43), the liquid moderator loop (43) comprising a moderator pump (44) for circulating a liquid moderator in the moderator loop (43), the liquid moderator loop (43) passing through the nuclear reactor core (2), and preferably passing through a liquid moderator heat exchanger (40)
wherein the at least one thermodynamic condition preferably comprises one or more of:
liquid moderator temperature at a position between a liquid moderator outlet of the liquid moderator heat exchanger (40) and a liquid moderator inlet of the nuclear reactor core (2),
liquid moderator temperature at a position between a liquid moderator outlet of the nuclear reactor core (2), and a liquid moderator inlet of the liquid moderator heat exchanger (40),
liquid moderator flow rate, the liquid moderator flow rate preferably being derived from the rotation speed of the tertiary pump (44).

18. The nuclear reactor according to claim 1, wherein the at least one controller (50) is configured to provide an output value, the output value comprising one or more of:
speed of the primary pump (4),
speed of a secondary pump (14),
speed of a tertiary pump (44),
speed of a liquid moderator pump (64),
speed of a blanket salt pump,
ending operation of the primary pump (4),
ending operation of a secondary pump (14),
ending operation of a tertiary pump (44),
ending operation of a liquid moderator pump (64),
ending operation of a blanket salt pump,
starting operation of the primary pump (4),
starting operation of a secondary pump (14),
starting operation of a tertiary pump (44),
starting operation of a liquid moderator pump (64),
starting operation of a blanket salt pump.

19. The nuclear reactor according to claim 1, wherein the at least one controller (50) comprises one or more of analog electronics, digital electronics and software for processing electronics values, mechanical logic, hydraulic and/or fluidic logic, and wherein the at least one controller (50) preferably does not comprise an electronic digital programmable computer.

20. The nuclear reactor according to claim 1, wherein the at least one controller (50) is configured to perform one or more of:
adjusting primary pump speed to keep the fuel salt temperature at the fuel salt outlet (7) to approximately 700° C., preferably comprising decreasing primary pump speed to increase the fuel salt temperature at the fuel salt outlet (7), and increasing primary pump speed to decrease the fuel salt temperature at the fuel salt outlet (7),
adjusting a liquid moderator pump speed, which adjusts a liquid moderator level in the nuclear reactor core (2) and thus the reactivity, to keep the average temperature between a fuel salt inlet (6) and a fuel salt outlet (7) to approximately 650° C., preferably comprising increasing moderator pump speed to increase reactivity and decreasing moderator pump speed to decrease reactivity,
adjusting secondary pump speed to keep the fuel salt temperature at the fuel salt inlet (6) to approximately 600° C., preferably comprising increasing a secondary pump speed to decrease the temperature of the fuel salt at the fuel salt inlet (6) and decreasing a secondary pump speed to increase the temperature of the fuel salt at the fuel salt inlet (6),
adjusting moderator coolant pump speed to keep the temperature of the liquid moderator at the liquid moderator outlet of the nuclear reactor core (2) at approximately 40° C., preferably comprising increasing liquid moderator pump speed to decrease the temperature of the liquid moderator at the liquid moderator outlet of the nuclear reactor core (2), and decreasing liquid moderator pump speed to increase the temperature of the liquid moderator at the liquid moderator outlet of the nuclear reactor core (2).

21. The nuclear reactor according to claim 1, wherein the at least one controller (50) is configured to operate as a controller having proportional, integral and/or derivative components, and/or as to operate as a Model Predictive Controller.

22. The nuclear reactor according to claim 1, wherein the heat exchange pump (4) is provided with a driver that receives a pump rotational speed signal from the at least one controller (50), wherein a secondary pump (14), a tertiary pump (44) and/or a liquid moderator pump (64) is/are provided with a driver that receives a pump rotational speed signal from the at least one controller (50), preferably each driver being powered with electrical power from electrical power source (53) in the interior and each driver receiving electrical power via a circuit breaker (19,29,49).

23. A method of operating the nuclear reactor according to claim 14, comprising determining the power output of the molten salt nuclear reactor by controlling the amount of power absorbed by the internal as well as external heat exchange medium flowing through the heat exchange medium conduit (23), preferably by controlling the flow rate of the internal as well as external heat exchange medium through the conduit (23).

24. A method of operating a nuclear reactor that maintains a sustained nuclear fission chain reaction, the nuclear reactor comprising a closed and preferably leaktight vessel (1), the vessel (1) having an interior (30,35), the interior (30,35) of the vessel (1) containing:
a nuclear reactor core (2) of the nuclear reactor, the nuclear reactor core (2) having a power output during the sustained nuclear fission chain reaction,
at least a primary heat exchange loop (3) of the nuclear reactor, the primary heat exchange loop (3) comprising a primary heat exchange medium pump (4) for circulating a primary heat exchange medium in the primary heat exchange loop (3), and
a conduit (23) of the nuclear reactor, the conduit (23) being configured for transporting an internal as well as external heat exchange medium, the conduit (23) fluidically connecting an inlet (38) of the nuclear reactor with an outlet (39) of the nuclear reactor,
the inlet (38) penetrates the exterior of the vessel (1), and the outlet (39) penetrates the exterior of the vessel (1),
a heat exchanging arrangement of the nuclear reactor, the heat exchanging arrangement being configured for exchanging heat between the primary heat exchange medium and the internal as well external heat exchange medium,
characterized by the method comprising
autonomously controlling the operation of the nuclear reactor, including the power output of the nuclear reactor core (2) by adjusting the sustained nuclear fission chain reaction, relying exclusively on data originating inside the vessel (1), at least some of the data originating inside the vessel (1) originating from one or more sensors of the nuclear reactor arranged inside the vessel (1), the data originating from within the vessel (1) preferably comprising at least one thermodynamic condition of the primary heat exchange medium.

25-42. (canceled)
